(19) United States
(12) Patent Application Publication
(10) Pub. No.: US 2012/0271780 A1
(43) Pub. Date: Oct. 25, 2012

(54) TREASURY PRICING SALES TOOL

(75) Inventors: Kathleen J. Perugini, Cheshire, CT (US); Idris Dawodu, London (GB); Tygere M. Gibbs, Charleston, SC (US); Kimberly A. Ursini, West Simsbury, CT (US)

(73) Assignee: BANK OF AMERICA CORPORATION, Charlotte, NC (US)

(21) Appl. No.: 13/090,204

(22) Filed: Apr. 19, 2011

(51) Int. Cl. G06Q 40/00

(52) U.S. Cl. 705/36 R

(57) ABSTRACT

A method for providing a treasury pricing tool includes retrieving data from one or more source databases, initiating presentation, using a processing device, of a user interface configured to present some or all the data to a user, receiving input regarding a product pricing recommendation, presenting, via the user interface, one or more reports configured to assist the user in making a final determination regarding product pricing, and receiving user input regarding a final product pricing recommendation. In some embodiments, the data may include product pricing data, risk data, credit data, profitability data and/or liquidity data. In some embodiments, the method also includes communicating the final product pricing recommendation from the user to a second user and receiving, from the second user, approval for the final product pricing recommendation.

### FIELD

In general, embodiments of the invention relate to systems for providing a treasury pricing tool for a user. More specifically, embodiments of the invention relate to systems for providing a treasury pricing tool including presentation of various types of data useful to a user in making a pricing recommendation.

### BACKGROUND

Historically, a pricing event is a manually driven process typically reviewed annually or over the course of a long period of time. Pricing decisions are generally focused on and include consideration for standard pricing increases, such as those generally accepted in the field, for example, inflationary pricing increases. Pricing decisions are also generally focused on and include consideration for exception pricing reviews, that is, for circumstances outside the standard or normal operating procedure for pricing changes. An example may be the sudden and sustained drop or increase in a particular market for goods directly affecting the subject matter being considered for the pricing decision. Pricing events are critical to remaining competitive in an industry such as the financial product industry. Regularly evaluating product pricing offers additional benefits such as allowing greater income generation. The product pricing event may involve an extension review and analysis of price points in view of the predicted impact on a specific client and/or group of specific clients. In some instances, product pricing is considered for all products intended for a particular client such that an overall impact for the client may be determined. This has historically been performed by individual product, sales and/or client managers or officers familiar with various pieces of data regarding the client and/or product.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

According to embodiments of the invention a method for providing a treasury pricing tool includes retrieving data, the data retrieved from a one or more source databases. The method also includes initiating presentation, using a processing device, of a user interface configured to present some or all the data to a user, receiving input regarding a product pricing recommendation, presenting, via the user interface, one or more reports configured to assist the user in making a final determination regarding product pricing, and receiving user input regarding a final product pricing recommendation.

In some embodiments, the method also includes communicating the final product pricing recommendation received from the user to a second user and receiving, from the second user, approval for the final product pricing recommendation. In some embodiments, presenting one or more reports comprises presenting a recommendation analysis report to the user. In some embodiments, presenting one or more reports comprises presenting a forecast report to the user. In some embodiments, the method further includes preparing one or more pricing exception decisions and communicating the one or more pricing exception decisions to the user. In some embodiments, the method also includes receiving one or more client impact evaluations from the user and storing the one or more client impact evaluations, thereby making the one or more client impact evaluations available for presentation via the user interface to the user or a second user.

In some embodiments, the method also includes communicating one or more insulation or detail requests to a second user and receiving input from the second user regarding whether each of the one or more insulation or detail requests is approved. In some such embodiments, the method further includes communicating whether the one or more insulation or detail requests is approved to the user. In some of these embodiments, at least one of the one or more insulation or detail requests is declined based on the input received from the second user, and the method also includes receiving one or more responses from the user regarding the one or more declined insulation or detail requests and communicating the one or more responses to the second user.

In some embodiments, the data comprises product pricing data. In some embodiments, the data comprises risk data. In some embodiments, the data comprises credit data. In some embodiments, the data comprises profitability data. In some embodiments, the data comprises liquidity data.

In some embodiments, presenting one or more reports configured to assist the user in making a final determination regarding product pricing includes calculating, based at least in part on the product pricing recommendation, an overall fee impact. In some embodiments, receiving input regarding the product pricing recommendation comprises receiving input from a market team. In such embodiments, presenting one or more reports comprises presenting the product pricing recommendation of the market team to the user for use in determining a final product pricing recommendation. In some embodiments, receiving input regarding the product pricing recommendation comprises receiving input from the user.

In some embodiments, retrieving data from one or more source databases includes communicating a plurality of requests for treasury data to a plurality of databases, each of the plurality storing treasury data in a different format, each of the plurality of requests for treasury data including instructions for configuring the treasury data in a normalized format. In some such embodiments, retrieving data from one or more source databases also includes receiving a plurality of responses to the plurality of requests, each of the plurality of responses comprising treasury data formatted in the normalized format. In some of these embodiments, the method also includes initiating presentation of some or all the treasury data formatted in the normalized format, via the user interface, to the user or a second user, wherein the treasury data comprises information regarding previous or current product pricing for one or more clients, the information useful in making the final product pricing decision.

According to embodiments of the invention, a system for providing a treasury pricing tool includes a processing device configured for retrieving data, the data retrieved from a one or more source databases. The processing device is also configured for initiating presentation of a user interface configured to present some or all the data to a user, receiving input regarding a product pricing recommendation, presenting, via the user interface, one or more reports configured to assist the user in making a final determination regarding product pricing, and receiving user input regarding a final product pricing recommendation.

In some embodiments, the processing device is further configured for communicating the final product pricing recommendation received from the user to a second user and receiving, from the second user, approval for the final product pricing recommendation. In some embodiments, presenting one or more reports comprises presenting a recommendation analysis report to the user. In some embodiments, presenting one or more reports comprises presenting a forecast report to the user. In some embodiments, the processing device is further configured for preparing one or more pricing exception decisions and communicating the one or more pricing exception decisions to the user. In some embodiments, the processing device is further configured for receiving one or more client impact evaluations from the user and storing the one or more client impact evaluations, thereby making the one or more client impact evaluations available for presentation via the user interface to the user or a second user.

In some embodiments, the processing device is further configured for communicating one or more insulation or detail requests to a second user and receiving input from the second user regarding whether each of the one or more insulation or detail requests is approved. In some such embodiments, the processing device is further configured for communicating whether the one or more insulation or detail requests is approved to the user. In some of these embodiments, at least one of the one or more insulation or detail requests is declined based on the input received from the second user. In these embodiments, the system is further configured for receiving one or more responses from the user regarding the one or more declined insulation or detail requests and communicating the one or more responses to the second user.

In some embodiments, presenting one or more reports configured to assist the user in making a final determination regarding product pricing comprises calculating, based at least in part on the product pricing recommendation, an overall fee impact. In some embodiments, receiving input regarding the product pricing recommendation comprises receiving input from a market team. In such embodiments, presenting one or more reports comprises presenting the product pricing recommendation of the market team to the user for use in determining a final product pricing recommendation.

In some embodiments, receiving input regarding the product pricing recommendation comprises receiving input from the user.

According to embodiments of the invention, a computer program product has a non-transient computer-readable medium with computer-executable instructions for providing a treasury pricing tool. The instructions include instructions for retrieving data, the data retrieved from a one or more source databases, instructions for initiating presentation of a user interface configured to present some or all the data to a user, instructions for receiving input regarding a product pricing recommendation, instructions for presenting, via the user interface, one or more reports configured to assist the user in making a final determination regarding product pricing, and instructions for receiving user input regarding a final product pricing recommendation.

In some embodiments, the instructions also include instructions for communicating the final product pricing recommendation received from the user to a second user and instructions for receiving, from the second user, approval for the final product pricing recommendation. In some embodiments, the instructions for presenting one or more reports comprise instructions for presenting a recommendation analysis report to the user. In some embodiments, the instructions for presenting one or more reports comprise instructions for presenting a forecast report to the user. In some embodiments, the instructions further comprise instructions for preparing one or more pricing exception decisions and instructions for communicating the one or more pricing exception decisions to the user. In some embodiments, the instructions further comprise instructions for receiving one or more client impact evaluations from the user and instructions for storing the one or more client impact evaluations, thereby making the one or more client impact evaluations available for presentation via the user interface to the user or a second user.

In some embodiments, the instructions also include instructions for communicating one or more insulation or detail requests to a second user and instructions for receiving input from the second user regarding whether each of the one or more insulation or detail requests is approved. In some such embodiments, the instructions also include instructions for communicating whether the one or more insulation or detail requests is approved to the user. In some of these embodiments, at least one of the one or more insulation or detail requests is declined based on the input received from the second user, and the instructions further comprise instructions for receiving one or more responses from the user regarding the one or more declined insulation or detail requests and instructions for communicating the one or more responses to the second user.

In some embodiments, the instructions for presenting one or more reports configured to assist the user in making a final determination regarding product pricing comprise instructions for calculating, based at least in part on the product pricing recommendation an overall fee impact. In some embodiments, the instructions for receiving input regarding the product pricing recommendation comprise instructions for receiving input from a market team, and the instructions for presenting one or more reports comprise instructions for presenting the product pricing recommendation of the market team to the user for use in determining a final product pricing recommendation. In some embodiments, the instructions for receiving input regarding the product pricing recommendation comprise instructions for receiving input from the user.

According to embodiments of the invention, a method for providing a treasury pricing tool includes retrieving data comprising treasury data, credit data, and risk data, the data retrieved from a one or more source databases, initiating presentation, using a processing device, of a user interface configured to present some or all the treasury data, some or all the credit data, and some or all the risk data to a user, receiving input regarding a product pricing recommendation, storing one or more client impact evaluations, thereby making the one or more client impact evaluations available for presentation via the user interface to the user or a second user, presenting, via the user interface, one or more reports configured to assist the user in making a final determination regarding product pricing, the one or more reports comprising a report regarding one or more client impact evaluations, and receiving user input regarding a final product pricing recommendation.

In some embodiments, the method also includes communicating the final product pricing recommendation received from the user to a second user and receiving, from the second user, approval for the final product pricing recommendation. In some embodiments, presenting one or more reports comprises presenting a recommendation analysis report to the user. In some embodiments, presenting one or more reports comprises presenting a forecast report to the user. In some embodiments, the method also includes preparing one or more pricing exception decisions and communicating the one or more pricing exception decisions to the user. In some embodiments, the method also includes receiving one or more client impact evaluations from the user.

In some embodiments, the method also includes communicating one or more insulation or detail requests to a second user and receiving input from the second user regarding whether each of the one or more insulation or detail requests is approved. In some such embodiments, the method also includes communicating whether the one or more insulation or detail requests is approved to the user. In some of these embodiments, at least one of the one or more insulation or detail requests is declined based on the input received from the second user, and the method also includes receiving one or more responses from the user regarding the one or more declined insulation or detail requests and communicating the one or more responses to the second user.

In some embodiments, presenting one or more reports configured to assist the user in making a final determination regarding product pricing includes calculating, based at least in part on the product pricing recommendation, an overall fee impact and wherein storing one or more client impact evaluations includes storing the calculated overall fee impact. In some embodiments, receiving input regarding the product pricing recommendation comprises receiving input from a market team, and presenting one or more reports comprises presenting the product pricing recommendation of the market team to the user for use in determining a final product pricing recommendation. In some embodiments, receiving input regarding the product pricing recommendation comprises receiving input from the user.

According to embodiments of the invention, a method provides a treasury pricing tool including retrieving data, the data retrieved from one or more source databases, initiating presentation, using a processing device, of a user interface configured to present some or all the data to a user, receiving input regarding a final product pricing decision, and initiating implementation of the final product pricing decision.

In some embodiments, the method also includes presenting, via the user interface, one or more reports configured to assist the user in making the final determination regarding product pricing. In some such embodiments, the method also includes monitoring progress of implementation of the final product pricing decision. In some such embodiments, monitoring progress of implementation of the final product pricing decision includes initiating presentation of one or more progress reports, via the user interface, to the user or a second user, wherein the one or more progress reports comprise information regarding the progress of implementation of the final product pricing decision in view of one or more product pricing implementation goals.

In some embodiments, initiating implementation of the final product pricing decision includes initiating communication of product pricing information corresponding to the final product pricing decision to a plurality of billing applications configured for generating billing communications to one or more clients affected by the final product pricing decision.

In some embodiments, retrieving data from one or more source databases includes communicating a plurality of requests for treasury data to a plurality of databases, each of the plurality storing treasury data in a different format, each of the plurality of requests for treasury data including instructions for configuring the treasury data in a normalized format. In some such embodiments, retrieving data from one or more source databases also includes receiving a plurality of responses to the plurality of requests, each of the plurality of responses comprising treasury data formatted in the normalized format. In some of these embodiments, the method also includes initiating presentation of some or all the treasury data formatted in the normalized format, via the user interface, to the user or a second user, wherein the treasury data comprises information regarding previous or current product pricing for one or more clients, the information useful in making the final product pricing decision.

The following description and the annexed drawings set forth in detail certain illustrative features of one or more embodiments of the invention. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, wherein:

FIG. 1 is a combination flowchart and block diagram illustrating an environment 100 in which a treasury pricing sales tool system operates according to embodiments of the invention;

FIG. 2 is a combination flowchart and block diagram illustrating another environment 200 in which a treasury pricing sales tool system operates according to embodiments of the invention;

FIG. 3 is a block diagram illustration another environment 300 in which a treasury pricing sales tool system operates according to embodiments of the invention;

FIG. 4 is a flowchart illustrating a method 400 for providing a treasury pricing tool according to embodiments of the invention;

FIG. 5 is a flowchart illustrating a method 500 including additional steps for method 400 according to embodiments of the invention;

FIG. 6 is a flowchart illustrating a method 600 including additional steps for method 400 according to embodiments of the invention;

FIG. 7 is a flowchart illustrating a method 700 including additional steps for method 400 according to embodiments of the invention;

FIG. 8 is a flowchart illustrating a method 800 including additional steps for method 400 according to embodiments of the invention;

FIG. 9 is a flowchart illustrating a method 900 including additional steps for method 400 according to embodiments of the invention;

FIG. 10 is a flowchart illustrating another method 1000 for providing a treasury pricing tool according to embodiments of the invention; and

FIGS. 11A-11N are screenshots of the treasury pricing sales tool according to embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As mentioned above, the product pricing process or pricing event may be a drawn-out, cumbersome and inefficient process. Accordingly, several areas of the process have been identified for which improvement yields improved product pricing efficiency and results. Previous product pricing processes have been very cumbersome and inefficient due to the lack of automation and integration of information. This is a result of the fact that data files are generally moved between many different tools and systems, thereby requiring frequent exchange such as upload and download among systems, thus resulting in many copies of the data stored on various systems. In addition, multiple spreadsheets or other data presentation tools must typically be used in order to distill all relevant information regarding a particular pricing decision. Because the data collection process is performed manually, it can be a very drawn-out and inefficient process. Furthermore, because of the manual nature of the data gathering, presentation and ultimately, the pricing determination, opportunities for auditing the process are likewise inefficient or altogether impossible.

According to embodiments of the invention, a method for providing a treasury pricing tool includes retrieving data from one or more source databases, initiating presentation, using a processing device, of a user interface configured to present some or all the data to a user, receiving input regarding a product pricing recommendation, presenting, via the user interface, one or more reports configured to assist the user in making a final determination regarding product pricing, and receiving user input regarding a final product pricing recommendation. In some embodiments, the data may include product pricing data, risk data, credit data, profitability data and/or liquidity data. In some embodiments, the method also includes communicating the final product pricing recommendation from the user to a second user and receiving, from the second user, approval for the final product pricing recommendation. Thus, embodiments of the invention may provide a model of a pricing action based on numerous pieces of data brought together by the system. A user may then analyze the model in order to determine whether the pricing action is appropriate for the particular client or group of clients. In this regard, the user may also submit a first proposed pricing action to a supervisor or manager and await feedback from the manager regarding the proposed pricing action. Ultimately, the embodiments of the tool of the invention offer transparency into the product process including insight regarding client impact in order to support final decision making regarding product pricing. The tool may also create periodic or regular reporting in order to ensure the pricing event or pricing action is on pace with regard to a predetermined schedule. Finally, in various embodiments, the tool may output the necessary documentation and/or communications to ensure the final pricing decisions are implemented correctly for every client for which pricing decisions have been made.

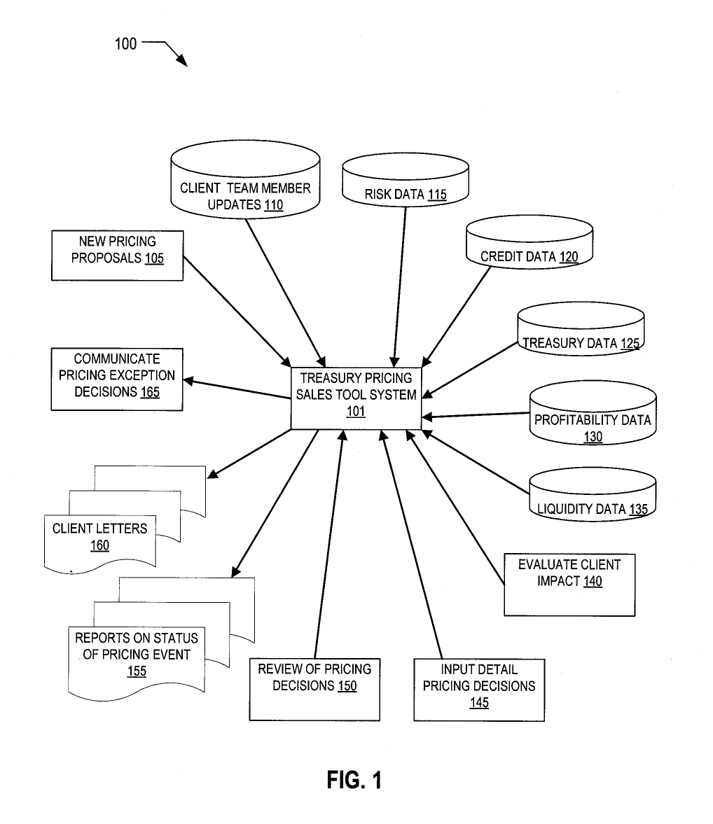

Referring now to FIG. 1, a combined block diagram and flowchart illustrates a pricing event environment 100 in which a treasury pricing sales tool system 101 in accordance with embodiments of the invention. The system 101 interacts with a variety of databases or datastores, other systems, workstations, and users communicating with the system via one or more connected devices. As shown in block 105, one of the first steps in a pricing event is for new pricing proposals to be submitted to the system 101, which receives the new pricing proposals, and in some embodiments, stores them either locally at the system 101 or in a remote datastore. Next, and periodically throughout the pricing event, the system receives client team member updates as represented by block 110. In some embodiments, the team member updates are made on a regular or periodic basis, and in other embodiments, the team member updates are made as needed. For example, when one or more members of a client team either leave the client team or join the client team, the system may receive an update regarding the members of the client team. In other embodiments, whenever the system 101 has a need for knowing the client team members, it communicates a request for the current client team members to a client entity database, which then returns information to the system 101 regarding the current client team members.

As indicated before, in some embodiments, the client entity database (CED) stores the team members, associates, managers, sales officers or the like who are team members. A client team member is typically a person or entity associated and/or responsible for the pricing relationship and/or arrangement with a client, or in some instances a group of clients sharing a common arrangement. The CED may also store information regarding each client, specifically regarding the product pricing currently being used for the client or a group of clients. The system may retrieve data from the CED database in order to access which people or teams are responsible for each client. This information may be useful, for example, if one or more people go on vacation, so that the clients are properly serviced. The system, in some embodiments, provides information regarding a particular associate's clients such that the associate is able to use the information during the pricing event. In some embodiments, only authorized personnel may view sensitive information regarding a client, and therefore, it may be important for the system to know which personnel are associated with the client and authorized to view the sensitive information. In some embodiments, the system 101 only provides sensitive client data to individuals identified by the CED as associated with the client. For example, only authorized individuals may be able to view client detail regarding a pricing event.

In various embodiments, the system 101 retrieves risk data 115 from one or more databases. The risk data may be based on the industry of the client that is being evaluated in comparison to the client itself. For example, the risk data may represent whether the client is a stable player within the applicable market, whether the client is a growing player within the applicable market, or whether the client is a declining player within the applicable market. In this example, a growing client may be deemed a low risk, whereas a declining client may be deemed a high risk. The risk data, in some embodiments, includes a classification of the various clients being considered in the pricing event. In some instances, the risk data includes data reflecting various credit ratings, scores or evaluations of the client as well as data related to the types of products the client has been involved with in the past. In some applications, the risk data takes into account these various components in order to determine the client's particular risk classification. An example of risk classifications is an “exit” client, a “stable” client or a “growing” client. As discussed above regarding the client declining in the market, the “exit” client may be assigned the highest risk whereas the “growing” client may be assigned the least risk in relation to the other clients in the market. In some embodiments, the system retrieves the risk data and then presents the risk data using the treasury pricing tool of the system. The tool, which includes a user interface, presents some or all the risk data to one or more authorized users or managers of the client. The risk data may be helpful for making product pricing choices. In some embodiments, where a client has a higher risk rating, the sales associate may ultimately recommend a higher product pricing based in part on the higher risk rating in relation to the client's peers in the market. Conversely, the sales associate may recommend a lower product pricing based on a lower risk rating in relation to the client's peers in the market.

In some embodiments, the system 101 retrieves credit data 120 from one or more databases. The credit data 120, in some embodiments, includes data regarding a client's relationship with a particular financial institution, such as a bank. In some embodiments, the financial institution is the owner and/or administrator of the system 101 and provides the treasure pricing tool in order to assist its associates during a pricing event in order to more effectively and efficiently arrive at final pricing decisions for each client. In other embodiments, the credit data 120 includes data across a wider range of inputs, for example, across the client's entire portfolio of financial interaction. The credit data is, in some embodiments, is only factual data. For example, the data may include an indication that a client took a loan on a specific date of a specific amount. In some such embodiments, the risk data 110, discussed above, includes credit data in coming to a decision and/or classification regarding the risk of a client. The credit data 120, in these embodiments, may be presented to a sales associate for use in making a pricing decision.

In some embodiments, the system 101 retrieves treasury data 130 from one or more databases. The treasury data 130 is data related to product pricing for the various clients of the financial institution. For example, some clients may be classified as standard pricing and others may be classified under special pricing arrangements. In various instances, the classifications for each particular client may vary widely based on the specific arrangement with that client. The treasury data 125 may include data associated with both domestic and foreign products, thereby providing a comprehensive view of the client's current and/or previous product pricing. The treasury data 125 may be retrieved from a storage warehouse, such as a consolidation warehouse configured for consolidating data flowing from multiple sources having various formatting or posing other integration challenges. Client pricing, billing, and revenue data and other data may be retrieved from these multiple sources, both domestic and foreign and then communicated to the system 101. Pulling treasury data 125 from the multiple sources and providing the data to the sales associate in the treasury pricing sales tool allows the sales associate to perceive a comprehensive view of client product pricing. When the system 101 retrieves the treasury data, it communicates a request to the various databases housing the treasury data 125, and within the request, the system 101 includes formatting requests for the data, such that the databases themselves and/or the consolidation warehouse answer the request by providing the treasury data in a normalized format easily readable by the system 101. The system 101 may then present some or all the treasury data to the sales associated for use in making a product pricing decision.

In some embodiments, the system 101 retrieves profitability data 130 from one or more databases. The profitability data 130 is data related to profitability of the client. The profitability of the client is another input for consideration by the sales associate in making a product pricing decision. In some embodiments, the system 101 retrieves liquidity data 135 from one or more databases. The liquidity data 135 is data related to the liquidity of the client. The liquidity data 135 may be one or more calculations provided by a database and/or server, which in some embodiments, is provided by the financial institution for the system 101.

As represented by block 140, one or more sales associates, officers, team members, or teams evaluate the client impact with regard to a particular product pricing proposal. The system 101 provides a user interface including information and data as discussed above, for example, the level of current pricing and a proposed pricing scheme. The proposed price, in various embodiments, is input by another sales officer or a product group and received by the treasury pricing sales tool system 101. The tool then calculates the overall impact to the client. For example, if a client has five price points for which it is typically billed, and the total bill typically averages $50.00 per month, the tool of the system 101 may calculate the overall impact to the client of a pricing change. In this example, the tool may calculate how the proposed pricing recommendation or recommendations would affect the per month billing for the client. For example, if two of the price points for which the client is typically billed per month go up a proposed amount of $5.00 per month, then the total per month client impact will be $10.00 per month with the total expected client bill calculated to be $60.00. The tool is configured for communicating this client impact to any user tasked with evaluating the client impact and the proposed pricing scheme, such as the sales officer or a manager making a final product pricing decision.

Thus, as represented by block 150, the sales officer or manager may review the overall client impact, in addition to the various other pieces of information, using the tool's user interface. The user interface is configured to receive input regarding whether to approve the proposed pricing decisions, thereby making them final pricing decisions and/or whether to insulate one or more clients from one or more proposed pricing decisions. In some embodiments, the system 101 provides the user the opportunity to decline a proposed pricing decision, and in other embodiments, the system 101 provides the user the opportunity to either insulate or decline one or more proposed pricing decisions. In various other embodiments, the sales officer may request changes in pricing based on percentages of increase of overall billings or some other criteria by which to dictate pricing changes. The tool is then configured for calculating a new client impact based on the desired percentage or other type of requested pricing changes, and then presenting an overall client impact statement regarding those newly presented proposed pricing arrangements. The sales officer is thereby given vision into the impact of any or all proposed pricing changes, an opportunity to review various alternative arrangements for pricing changes, and, in some instances, the power to approve, decline or insulate one or more clients with regard to various proposed pricing changes. In various embodiments, a first sales officer makes a proposed pricing decision based on the information provided by the tool, and then a managing sales officer reviews the proposed pricing decision and then issues a final pricing decision. In some such embodiments, one or both the sales officer and the managing sales officer utilize the tool, and specifically the tool's capabilities with regard to retrieving and presenting numerous types of information regarding the previous or current pricing, the client impacts with regard to various proposed pricing schema, in comparison with the client impact with regard to a potential final product pricing arrangement.

As represented by block 155, the system 101 initiates preparation and/or prepares one or more status reports on the pricing event on a regular/periodic basis and/or on demand. In some embodiments, only client team members identified by the CED as having sufficient authorization are permitted to access one or more of the status reports. For example, in some instances, a sales officer may only be involved with a pricing decision regarding one product and a second sales officer may be involved with a pricing decision regarding another product. A managing sales officer oversees both the first and the second sales officers and ultimately makes final product pricing decisions regarding both product in view of the overall client impact as calculated by the system 101. The managing sales officer or some other administrator or manager may deem is appropriate to prohibit access to status reports regarding the product pricing for which a particular sales officer is not involved. That is, a sales officer may only have access to the product pricing information and reporting regarding the particular product or products for which that sales officer is proposing pricing. Whereas, the managing sales officer, in most instances, has access to all information regarding the client in order to make final product pricing decisions in view of the overall client impact of all the proposed product pricings. In some embodiments, the system 101 also produces status reports regarding one or more product pricing events. For example, a managing sales officer may receive status reports regarding the pricing events for each of the ten clients for which the managing sales officer is a client team member.

In some embodiments, the on demand reports can provide the current sales officer input regarding proposed product pricing so that a managing sales officer may, at his or her discretion, review the current proposed product pricing regardless of whether the sales officer has proactively communicated a proposed product pricing to the managing sales officer. In this regard, the managing sales officer may work concurrently with several sales officers working to finalize their various product pricing decisions, such that, once the sales officers have finalized their proposed product pricing, the managing sales officers have been aware of the probable final proposed product pricing. Thus, the proposed pricing submitted by the sales officers to the managing sales officer is not a surprise to the managing sales officer. The tool of the system 101 provides this real time access to the pricing event in order to improve the efficiency of the pricing event.

As represented by block 160, the system 101 initiates preparation and/or prepares one or more client letters. The client letters, in various embodiments, include new pricing information for the client. In some embodiments, the client letters may include additional information regarding the pricing decision, such as one or more pieces of information used during the pricing event to justify increased or decreased pricing decisions. For example, in some embodiments, when the product pricing is increasing, the administrator of the system 101, for example, a financial institution, may deem it necessary or appropriate to explain rationale behind product pricing increases. The financial institution may indicate to the client that, based on recent debt increases, the client's overall credit evaluation, in comparison with the client's peers in the market, indicated that higher pricing was appropriate.

As represented by block 165, the system 101 communicates pricing exception decisions 165 to any affected billing systems maintained by the financial institution or other administrator of the system 101. In other words, once the final product pricing decisions have been made and input into the system 101, the system informs any billing systems associated with billing the client for the products affected by the final product pricing decisions of the final product pricing decisions. Thus, the billing systems, when preparing invoices or otherwise communicating with the client will reference the new pricing scheme. The billing systems, in some embodiments, include storage devices configured for storing the pricing information regarding the financial institution's products.

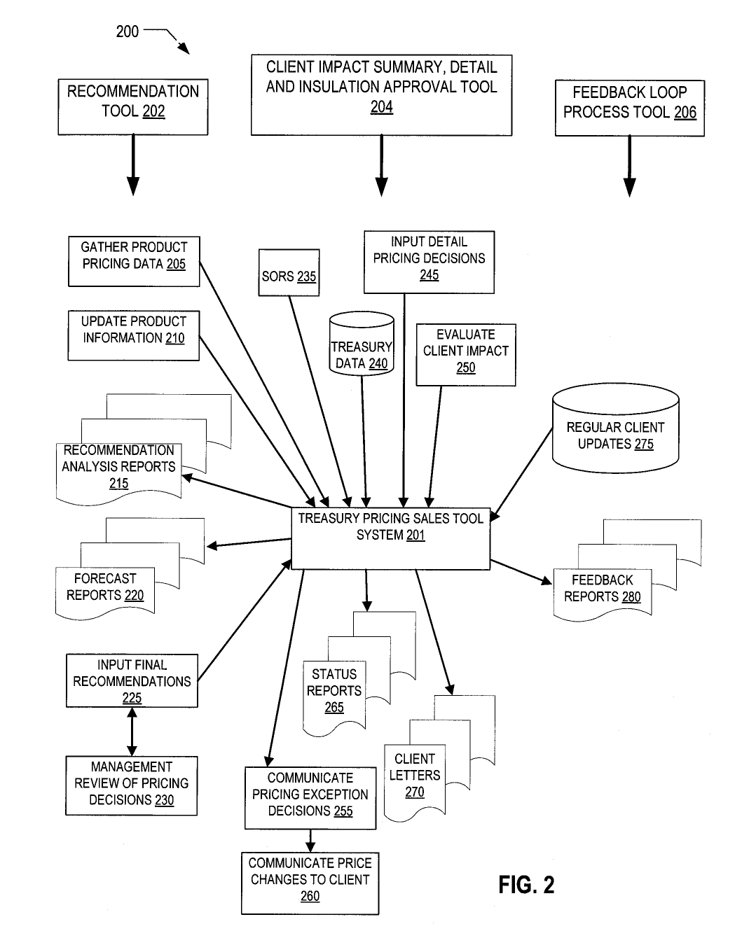

Referring now to FIG. 2, a combined block diagram and flowchart illustrates a pricing event environment 200 in which a treasury pricing sales tool system 201 in accordance with other embodiments of the invention. As shown, the environment 200 is categorized based on a recommendation tool 202, a client impact summary, detail, and insulation approval tool 204, and a feedback loop process 206. In various embodiments, some or all of each of tools 202, 204, and 206 are part of the treasury pricing sales tool provided by the treasury pricing sales tool system 201. Referring first to the left-hand column, which corresponds to the recommendation tool 202, the first step, as represented by block 205, is gathering product pricing data. The next step, as represented by block 210, is updating product information. In some embodiments, the product information being updated includes updating pricing information as well as updating client team member information. The next step, as represented by block 215 is providing to one or more sales officers and/or other client team members, one or more recommendation analysis reports. The recommendation analysis reports 215 may include information regarding a proposed product pricing calculated by the system 101. In some embodiments, forecast reports are generated and provided to the client team members, as represented by block 220. Next, the sales officer assigned to a particular product pricing event input a final product pricing recommendation, as represented by block 225. As represented by block 230, a managing sales officer or multiple managing sales officers review the final product pricing recommendation input by the sales officer(s) and provide an approval, denial or insulation decision regarding the final product pricing recommendation.

Referring now to the middle column, which corresponds to the client impact summary, detail and insulation approval tool 204, as discussed above with reference to FIG. 1, the treasury pricing sales tool system 201 may pull or retrieve data from a variety of sources. For example, as represented by datastore 240, the system 201 may retrieve treasury data related to the current or previous product pricing for the products associated with one or more clients. The treasury data, as discussed above, is typically accessed from more than one source database. Because of this, the system 201, in some embodiments, communicates a request for desired treasury data to each of the datastores housing relevant data. The request includes instructions for the various datastores to present the relevant treasury data in a normalized format to the system 201.

The system 201, of course, also receives sales officer recommendations (SORS), as represented by block 235. The SORS may be based on a sales officer review of a calculated proposed product pricing or may be formulated without use of a calculated proposed product pricing. In some embodiments, the system 201 does not receive SORS, but rather, proposes a calculated proposed product pricing and provides that to the managing sales officer who makes a decision regarding final product pricing. As represented by block 245, the sales officers also use the tool to perform a variety of other tasks and input various other decisions and/or recommendations. Block 245 refers to inputting detailed pricing decisions, which may include, in various embodiments, the sales officer inputting recommendations regarding pricing for various products, responding to insulation decline decisions issued from managing sales officers, making detailed pricing adjustments and the like. Referring now to block 250, the sales officer may input information regarding evaluating client impact either based on a pre-calculated overall client impact or based on the various pieces of information available to the sales officer through the tool. As represented by block 255, the system 201 may communicate pricing exception decisions to various billing systems and/or other systems as necessary based on the final product pricing decisions input by sales officers and/or managing sales officers.

As represented by block 260, the system, and/or other systems such as billing systems communicate pricing changes to the client. In some embodiments, standard pricing changes as well as pricing insulations are communicated to the client in order to provide useful information to the client. For example, a managing sales officer may perceive a benefit in communicating to a client that a pricing change has been insulated from that client. In this regard, the client may be pleased with the information, particularly if the client is experiencing pricing increases for some other product. In some embodiments, the system 201 automatically generates communications regarding pricing decisions to be sent to the client such as emails, textual alerts and/or messages, letters, facsimiles and the like. In other embodiments, the managing sales officer or other team member may instruct the system 201 to prepare specific correspondence to the client other than any correspondence that would normally be prepared and sent automatically.

As represented by block 265, status reports may be generated for team members requiring information regarding the pricing event. Additionally, in some embodiments, audit trail reports may be generated as necessary. As represented by block 270, and as indicated above regarding block 260, letters or other communications to client may be generated by the system 201.

Referring to the right-hand column of FIG. 2, the feedback loop process tool 206 is illustrated. As represented by block 275, regular client updates are input into the system 201. These updates may include information regarding team members, risk ratings, or other information relevant to the client that the team members may provide to the system, thereby making such information available via the treasury pricing sales tool. Further, as represented by block 280, feedback reports may be generated by the system 201 either regularly or on demand. The feedback reports may include information received from one or more clients as feedback regarding pricing decisions. In other embodiments, the feedback reports may include information regarding pricing decisions internal to the pricing event. For example, a managing sales officer may input information into the system explaining why a client has been insulted from a proposed pricing increase. Such feedback may be presented to the sales officer who prepared the proposed pricing increase so that the sales officer will be aware of the reasoning behind the insulation.

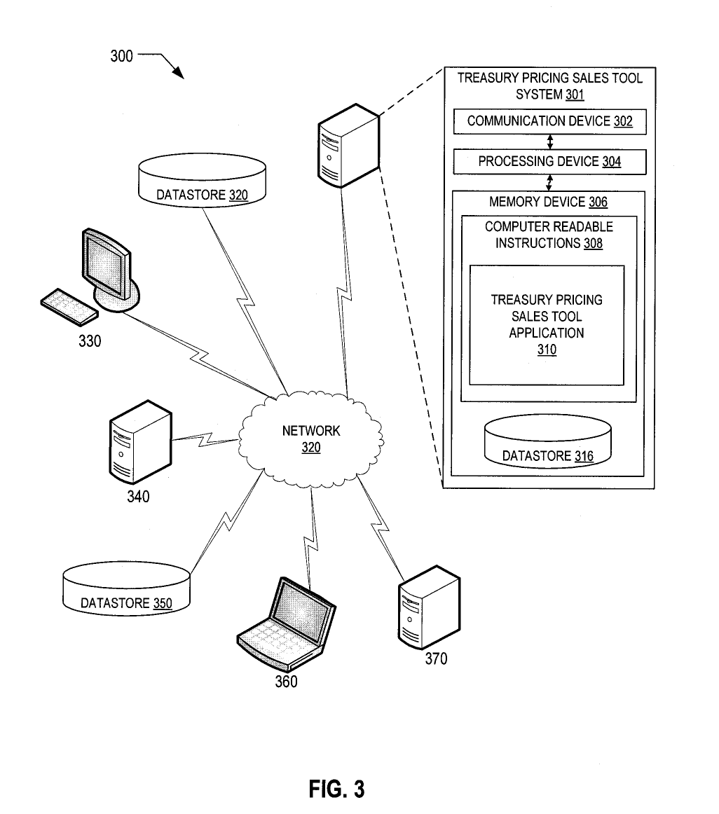

Referring now to FIG. 3, an environment 300 in which a customer treasury pricing sales system 301 operates is illustrated. The treasury pricing sales tool system 301 may, in various embodiments be configured for performing one or more of steps of one or more of the methods 300, 400, 500, 600, 700, 800, 900 and/or 1000, and in some embodiments including one or more additional steps. In the configuration shown, the treasury pricing sales tool system 301 communicates across a network 320 with one or more workstations, such as workstation 330 and/or laptop 360. The treasury pricing sales tool system 301 also communicates, in various embodiments, across the network 320 with one or more datastores or databases, such as datastore 320 or datastore 350. Additionally, the treasury pricing sales tool system 301 may communicate across the network 320 with one or more other system and/or servers, such as servers 340 and/or server 370.

This configuration is intended to illustrate that a sales officer, managing sales officer or other user (not shown) can interact with the treasury pricing sales tool system 301 using a variety of devices remote to the treasury pricing sales tool system 301. Furthermore, in some embodiments one or more users can interact with the treasury pricing sales tool system 301 locally such as through an input/output device attached directly with the treasury pricing sales tool system 301. This configuration is also intended to illustrate that the treasury pricing sales tool system 301 communicates with a number of sources of data, information or input as well as a number of output devices.

The treasury pricing sales tool system 301, in various embodiments, has a communication device 302 controlled by a processing device 304 in order to communicate across the network 320. The network 320 is an intranet, the Internet, a local area network, a wide area network, and/or any other electronic device network, and/or any combination of the same. The processing device 304 is also in communication with a memory device 306 configured for storing computer-readable and computer-executable instructions 308. The computer-readable instructions, in various embodiments, include one or more applications, such as a treasury pricing sales tool application 310.

Generally, in some embodiments, some, all or none of the method steps and/or sub-steps discussed above with reference to the various figures are embodied in computer-executable instructions within the treasury pricing sales tool application 310. In some embodiments, the application is divided into two or more parts that are contained within one application, and in other embodiments, the instructions for executing the treasury pricing sales tool application 310 are spread over two or more applications. In some embodiments, some of the instructions for executing the treasury pricing sales tool application 310 are stored on the treasury pricing sales tool system 301 and some of the instructions are stored on a user device, such as one of the workstations, laptops, servers or other user devices shown in FIG. 3. In some embodiments, some or all the instructions are stored remotely from the treasury pricing sales tool system 301 and accessed as necessary by the treasury pricing sales tool system 301 and/or any other device requiring instructions. Further, in some embodiments, the memory device 306 includes a datastore 316 configured for storing information and/or data such as the current or previous product pricing data and/or any other data retrieved from remote datastores and presented by the system. In some embodiments, the system 301 updates some or all the data or information at the request of the particular user using the tool, and in other embodiments, the system automatically updates data or information by retrieving the data or information from its source when presenting the data or information. In some instances, of course, some data or information presented by the tool is considered real time and therefore is updated automatically, and some data, such as the team members assigned to a particular client may only be updated periodically or on demand. In various other embodiments, data and/or information used by the system 301 in calculations and/or presented via the tool may be retrieved based on the type of information and/or data being used and/or presented.

In some embodiments one or more additional systems or servers are configured for communicating with the treasury pricing sales tool system 301. In some such embodiments, information regarding different clients may be stored in various locations on different systems as discussed above regarding treasury data. In some embodiments, a treasury pricing sales tool system 301 functions as a central control server and accesses the various pieces of customer information from various locations, thereafter presenting it to any users via the treasury pricing sales tool. In various other embodiments, multiple servers or systems function together as a central control server and access different pieces of data and/or instructions in order to initiate presentation of the treasury pricing sales tool.

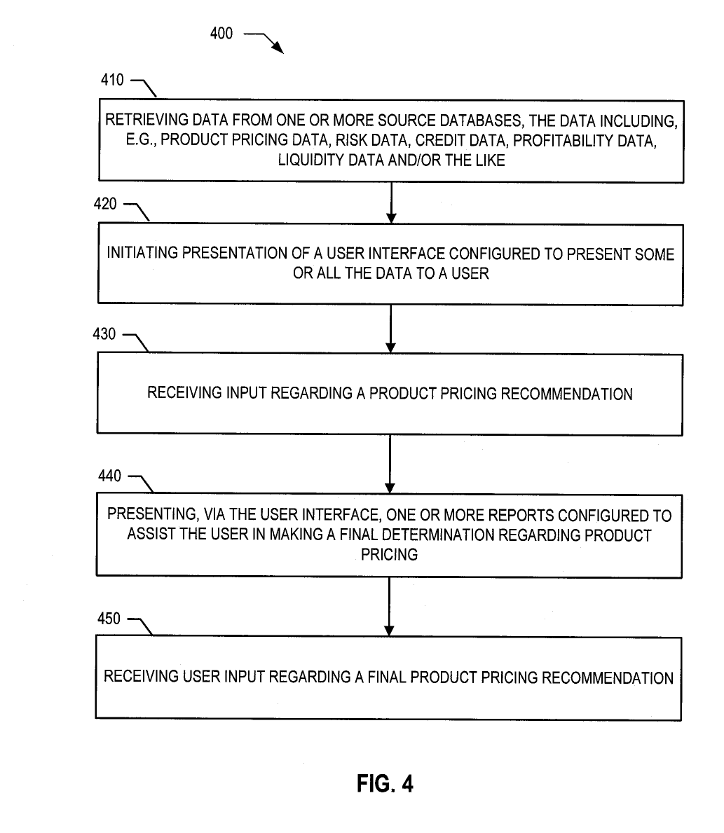

Referring now to FIG. 4, a flowchart illustrates a method 400 for providing a treasury pricing sales tool according to embodiments of the invention. The first step, as represented by block 410, is retrieving data from one or more source databases. In some embodiments, the data includes, for example, product pricing data, treasury data, risk data, credit data, profitability data, liquidity data and/or other types of data. The next step, as represented by block 120, is initiating presentation of a user interface configured to present some or all the data to a user. The next step, as represented by block 130, is receiving input regarding a product pricing recommendation. The next step, as represented by block 140, is presenting, using the user interface, one or more reports configured to assist the user in making a final determination regarding product pricing. The final step, as represented by block 150, is receiving user input regarding a final product pricing recommendation.

In some embodiments, retrieving data from one or more source databases includes communicating a plurality of requests for treasury data to a plurality of databases, each of the plurality storing treasury data in a different format, each of the plurality of requests for treasury data including instructions for configuring the treasury data in a normalized format. In some such embodiments, retrieving data from one or more source databases also includes receiving a plurality of responses to the plurality of requests, each of the plurality of responses comprising treasury data formatted in the normalized format. In some of these embodiments, the method also includes initiating presentation of some or all the treasury data formatted in the normalized format, via the user interface, to the user or a second user, wherein the treasury data comprises information regarding previous or current product pricing for one or more clients, the information useful in making the final product pricing decision.

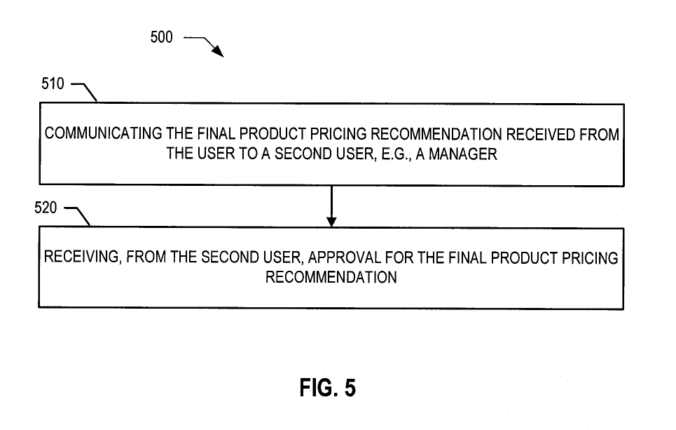

Referring now to FIG. 5, a flowchart illustrates a method 500 including optional steps that are included with one or more of the steps discussed with reference to the other methods discussed herein. The first step, as represented by block 510, is communicating the final product pricing recommendation received from the user to a second user. For example, in some embodiments, the second user is a manager. The next step, as represented by block 520, is receiving, from the second user, approval for the final product pricing recommendation.

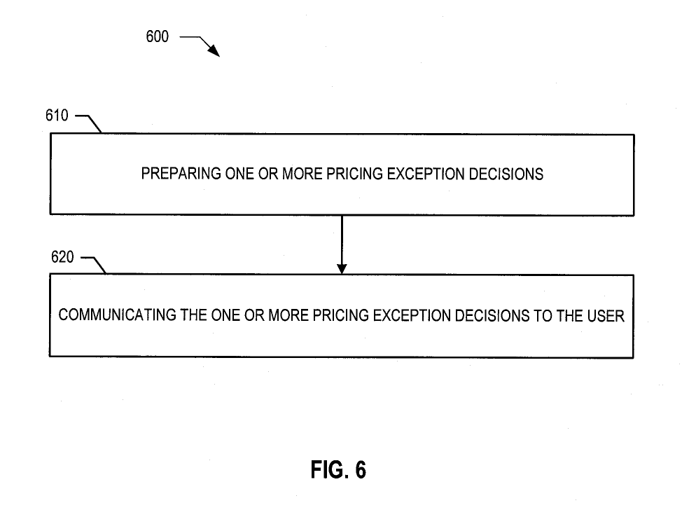

Referring now to FIG. 6, a flowchart illustrates a method 600 including optional steps one or more of which may be included with one or more of the steps discussed with reference to the other methods discussed herein. The first step, as represented by block 610, is preparing one or more pricing exception decisions. The next step, as represented by block 620, is communicating the one or more pricing exception decisions to the user.

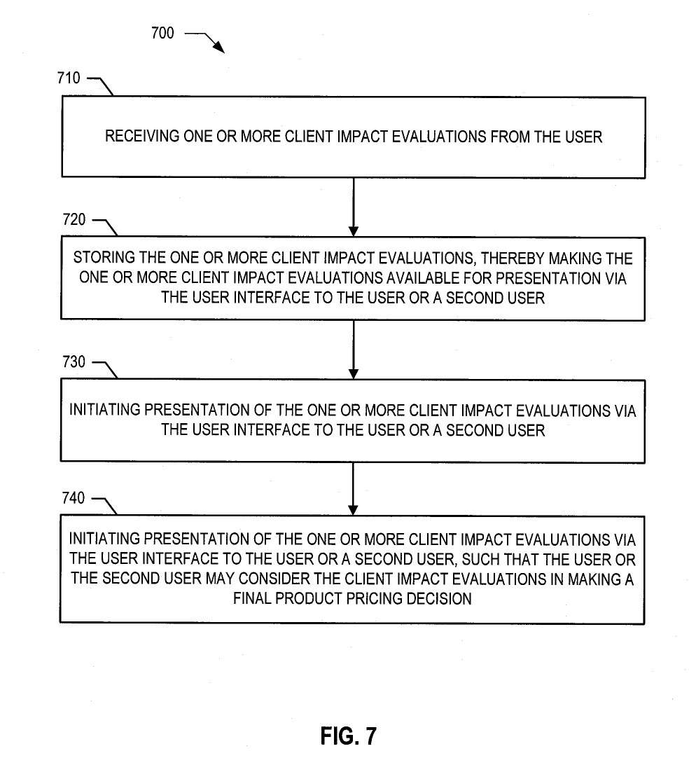

Referring now to FIG. 7, a flowchart illustrates a method 700 including optional steps one or more of which may be included with one or more of the steps discussed with reference to the other methods discussed herein. The first step, as represented by block 710, is receiving one or more client impact evaluations from the user. The next step, as represented by block 720, is storing the one or more client impact evaluations, thereby making the one or more client impact evaluations available for presentation via the user interface to the user. In some embodiments, the client impact evaluations are made available to a second user, such as, for example, a supervisor of the user. The next step, as represented by block 730, is initiating presentation of the one or more client impact evaluations via the user interface to the user and/or a second user, such as a supervisor of the user in various embodiments. The next step, as represented by block 740, is initiating presentation of the one or more client impact evaluations via the user interface to the user or a second user, such that the user or the second user may consider the client impact evaluations in making a final product pricing decision.

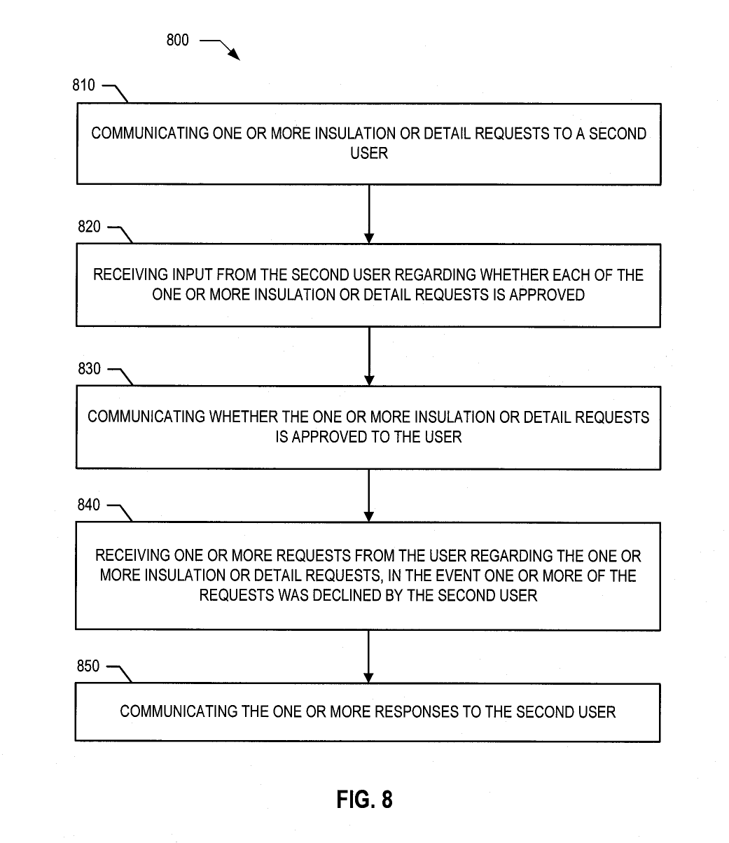

Referring now to FIG. 8, a flowchart illustrates a method 800 including optional steps one or more of which may be included with one or more of the steps discussed with reference to the other methods discussed herein. The first step, as represented by block 810, is communicating one or more insulation or detail requests to a second user. The next step, as represented by block 820, is receiving input from the second user regarding whether each of the one or more insulation or detail requests is approved. The next step, as represented by block 830, is communicating whether the one or more insulation or detail requests is approved to the user. The next step, as represented by block 840, is receiving one or more requests from the user regarding the one or more insulations or detail requests in the event one or more of the requests was declined by the second user. The next step, as represented by block 850, is communicating the one or more responses to the second user.

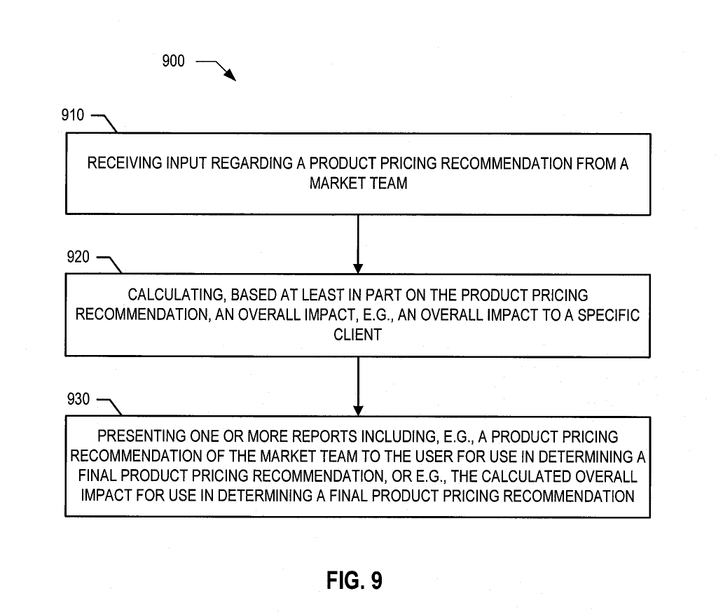

Referring now to FIG. 9, a flowchart illustrates a method 900 including optional steps one or more of which may be included with one or more of the steps discussed with reference to the other methods discussed herein. The first step, as represented by block 910, is receiving input regarding a product pricing recommendation from a market team.

The next step, as represented by block 920, is calculating, based at least in part on the product pricing recommendation, an overall impact. For example, in various embodiments, the overall impact is calculated with respect to a specific client and/or group of clients. The next step, as represented by block 930, is presenting one or more requests including, for example, a product pricing recommendation of the market team to the user. The recommendation, in various embodiments, may be used by the user and/or the second user or manager for determining a final product pricing recommendation. As another example of presenting a report, in various embodiments, the report may be or include the calculated overall impact for use by the user and/or second user or manager in determining a final product pricing recommendation.

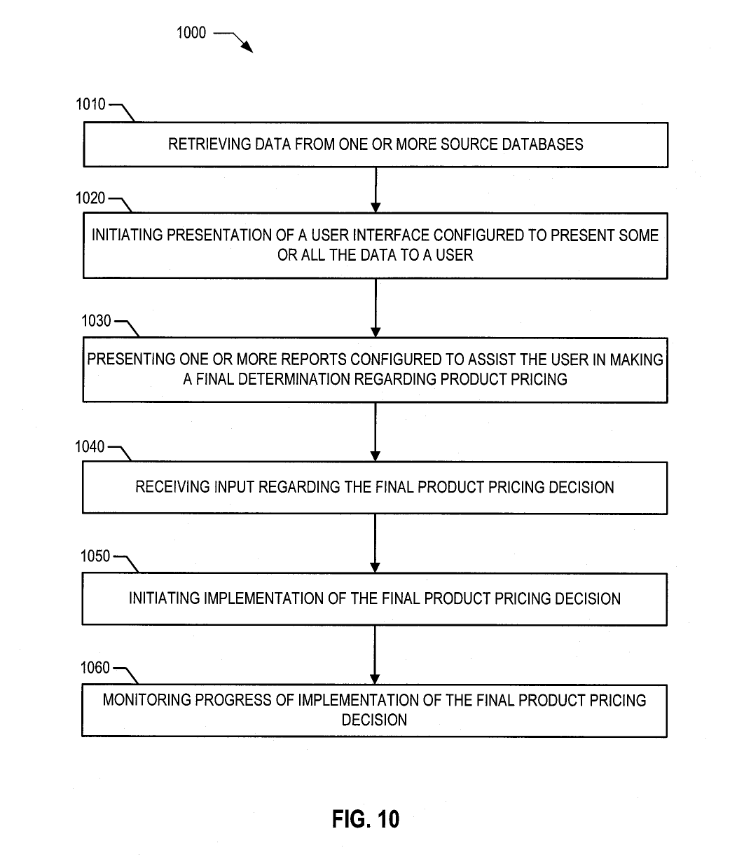

Referring now to FIG. 10, a flowchart illustrates another method 1000 for providing a treasury pricing tool according to embodiments of the invention. The first step, as represented by block 1010, is retrieving data from one or more source databases. The next step, as represented by block 1020, is initiating presentation of a user interface configured to present some or all the data to a user. The next step, as represented by block 1030, is presenting one or more reports configured to assist the user in making a final determination regarding product pricing. The next step, as represented by block 1040, is receiving input regarding the final product pricing decision. The next step, as represented by block 1050, is initiating implementation of the final product pricing decision. The final step, as represented by block 1060, is monitoring progress of implementation of the final product pricing decision.

In some embodiments, retrieving data from one or more source databases includes communicating a plurality of requests for treasury data to a plurality of databases, each of the plurality storing treasury data in a different format, each of the plurality of requests for treasury data including instructions for configuring the treasury data in a normalized format. In some such embodiments, retrieving data from one or more source databases also includes receiving a plurality of responses to the plurality of requests, each of the plurality of responses comprising treasury data formatted in the normalized format. In some of these embodiments, the method also includes initiating presentation of some or all the treasury data formatted in the normalized format, via the user interface, to the user or a second user, wherein the treasury data comprises information regarding previous or current product pricing for one or more clients, the information useful in making the final product pricing decision.

In various embodiments, the system of the invention is configured to create one or more fee schedules. A fee schedule, in most instances, is a document internal to a financial institution intended to be used by a sales officer or team as a quick reference. For example, in some instances, a fee schedule may include information regarding proposed pricing decisions and one or more types of data retrieved by the system, such as treasury data. Fee schedules may be created by the system for the purpose of supporting a sales officer during a pricing event, and more specifically while making a pricing decision.

In various embodiments, the system is configured to retrieve and/or calculate competitive data elements. For example, the system may retrieve published pricing information from a competing financial institution. In one embodiment, the system uses the retrieved market data for calculating useful numbers such as average and/or median. A sales officer may then use the retrieved and/or calculated competitive data elements, which may be presented using the tool of the system to compare current or proposed pricing schemes with the market for similar products.

In various embodiments, the system is configured to create regular or periodic notifications or alerts including applicable pricing information. The notification and/or alerts may be formatted in a variety of ways such as emails, instant messages, text messages, audio messages and the like. For example, in some embodiments, the system automatically populates or drafts an email communication indicating one or more pieces of information used during the pricing event, such as proposed pricing changes. In some embodiments, for example, the system communicates client reassignments, inconsistent pricing decisions or any other event deemed noteworthy to one or more sales officers or sales managers associated with a pricing event.

In various embodiments, the tool of the system receives user input regarding “resetting” data input. For example, after a user has made various decisions, such as, inputting a proposed pricing scheme for a variety of products associated with a client or inputting a proposed pricing scheme for products associated with all the clients in a group or family, the system provides an opportunity for the user to choose to reset the data having been input since a predetermined moment, such as when the user authenticated and logged onto the tool. In some embodiments, the tool also provides the user the opportunity to review scenarios and/or modeling regarding the present state of data and/or decisions having been input by the user in comparison to a previous state where data and/or decisions had not been input. That is, tool provides the user to compare a previous pricing scheme (before user input) to a proposed pricing scheme (included user input) including the respective client impacts and/or other information.

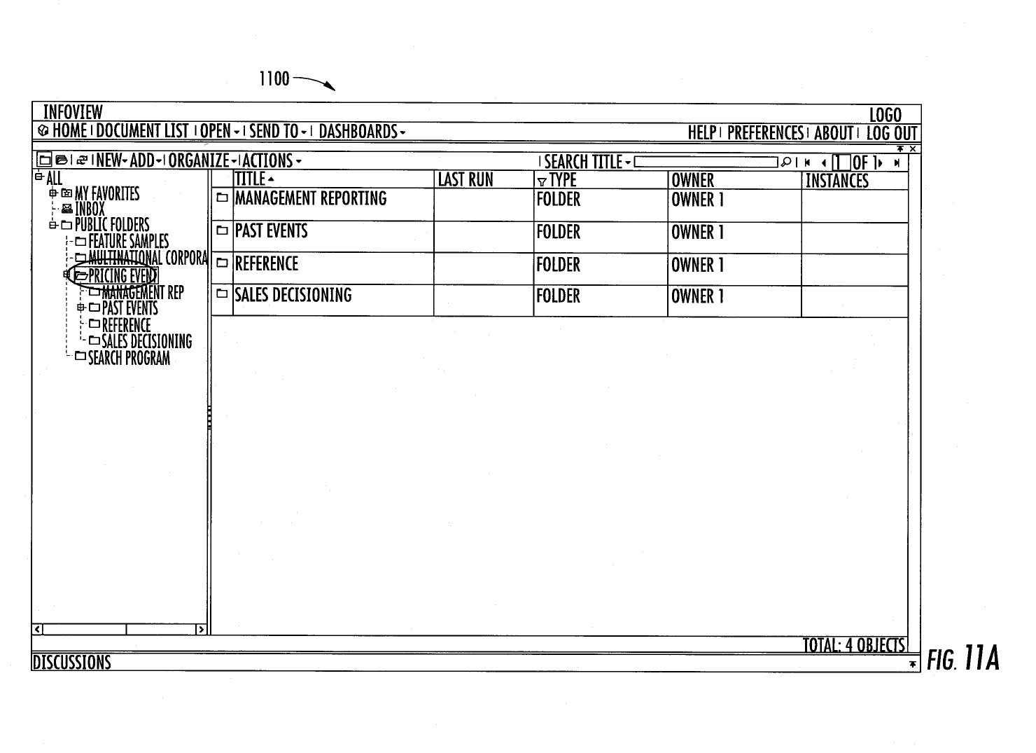

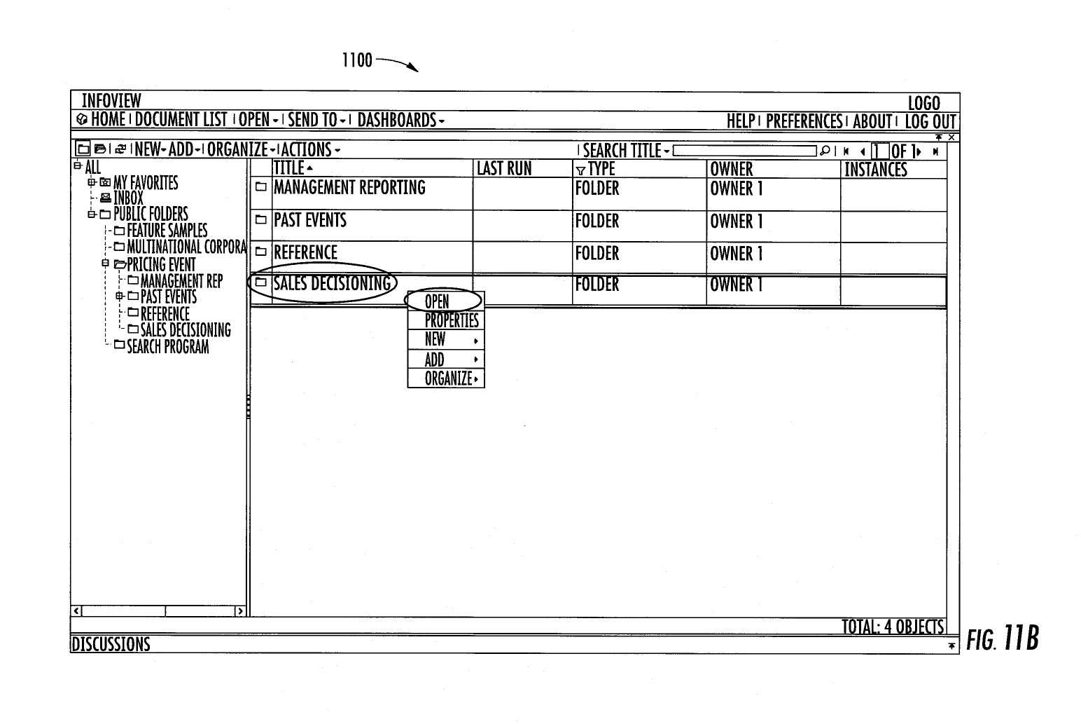

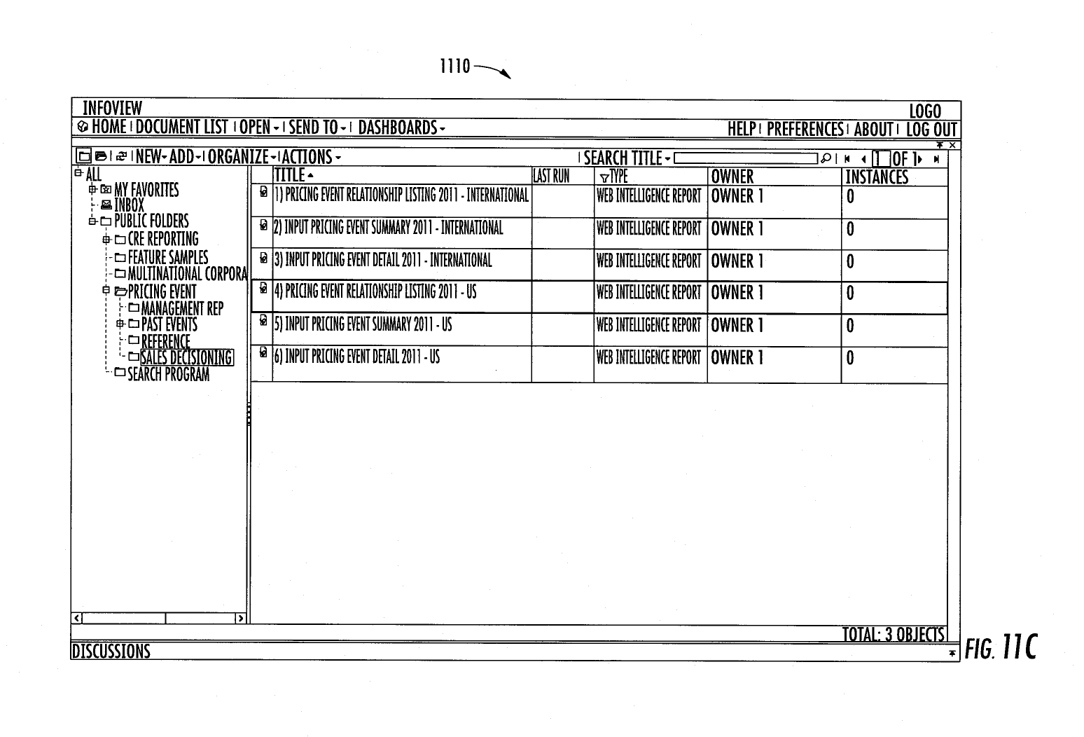

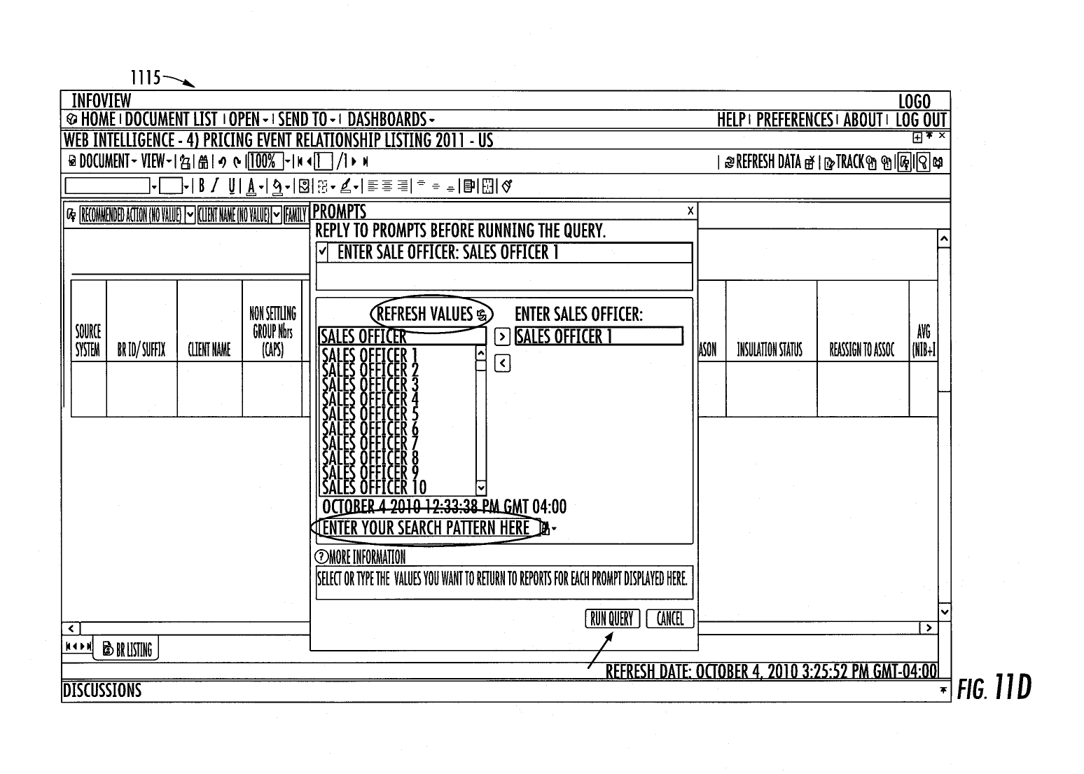

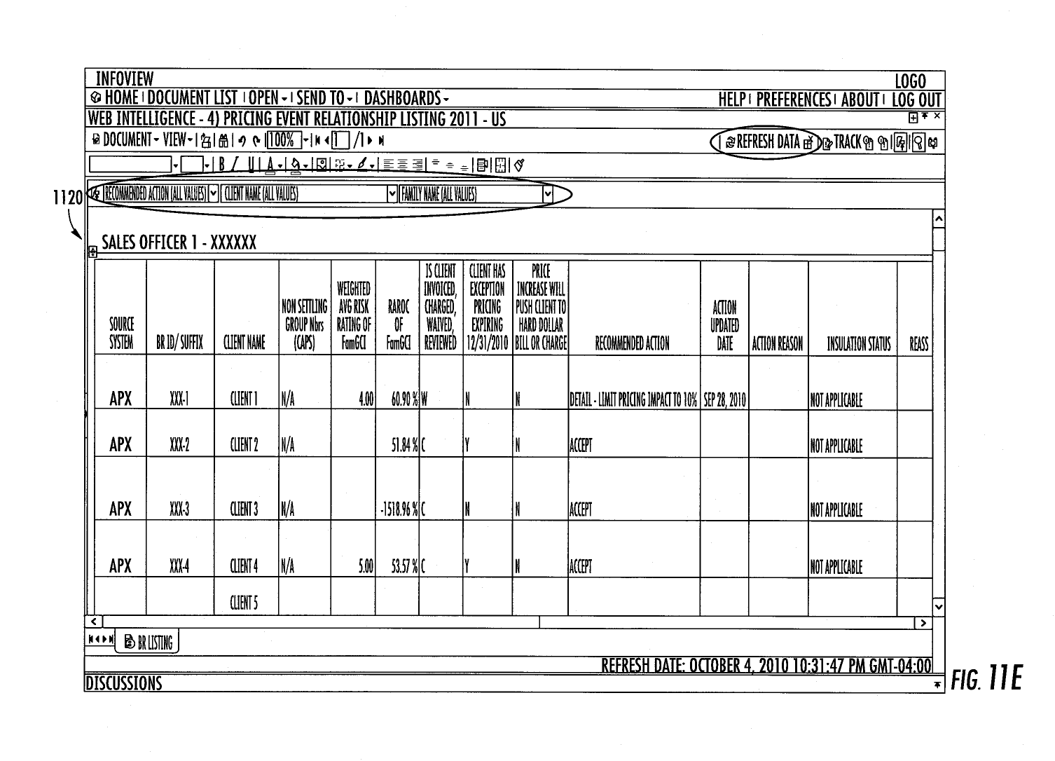

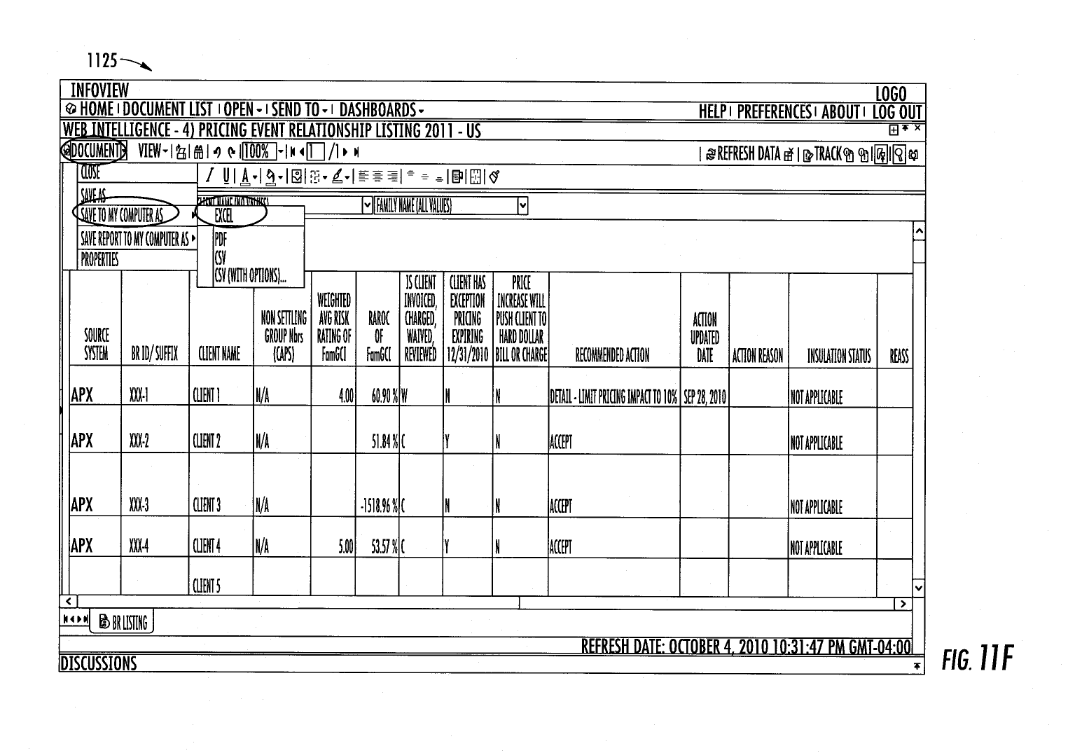

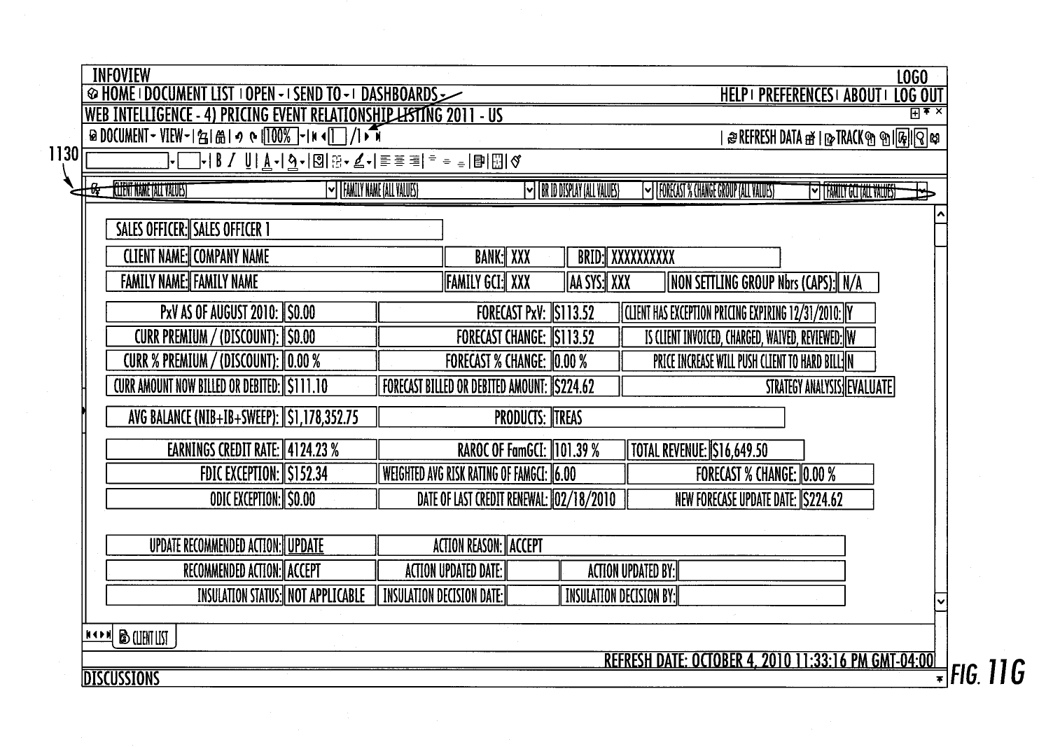

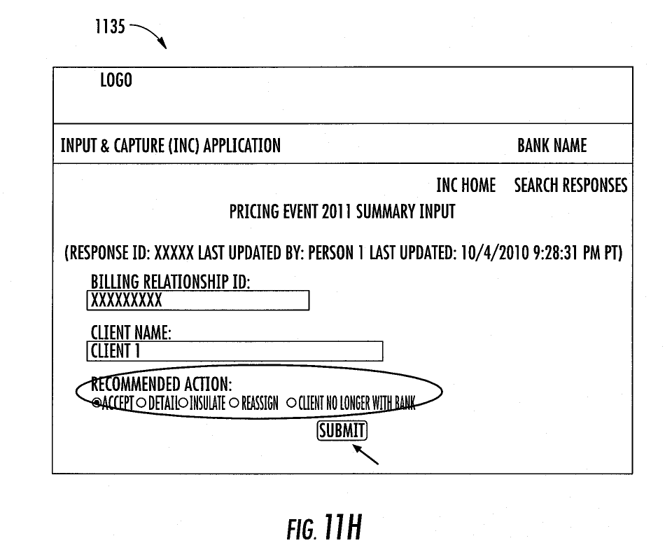

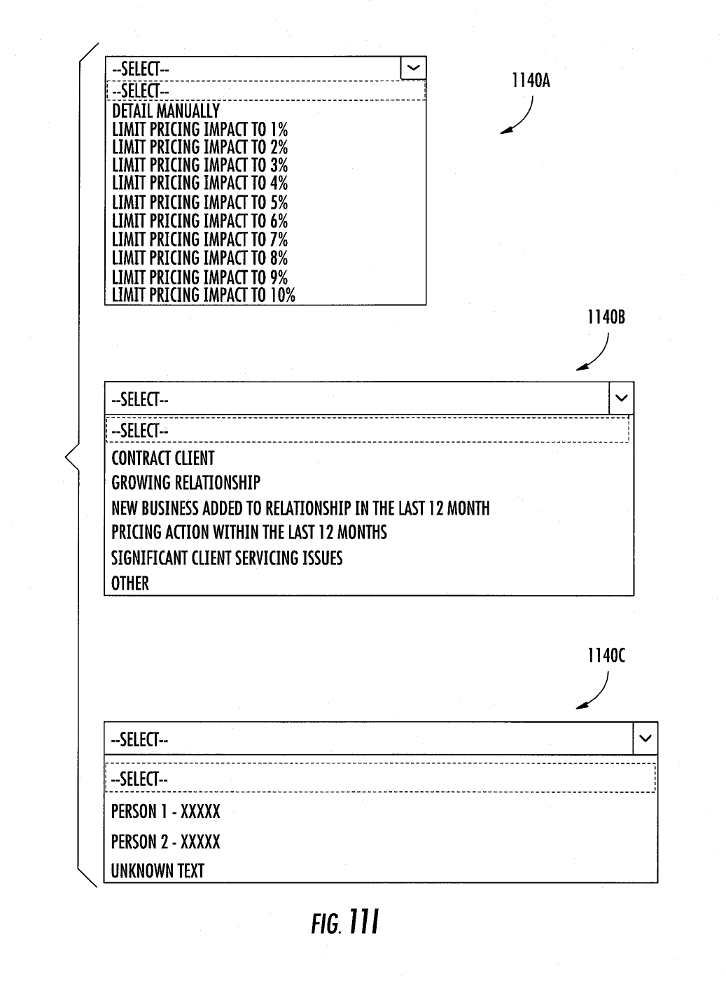

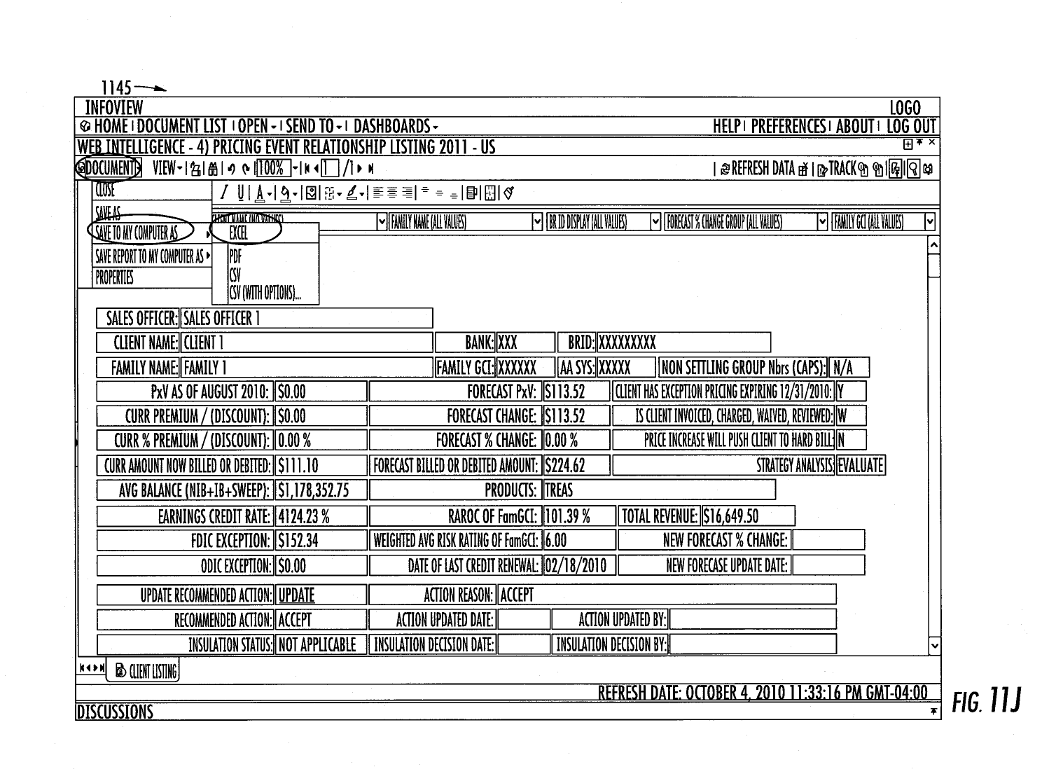

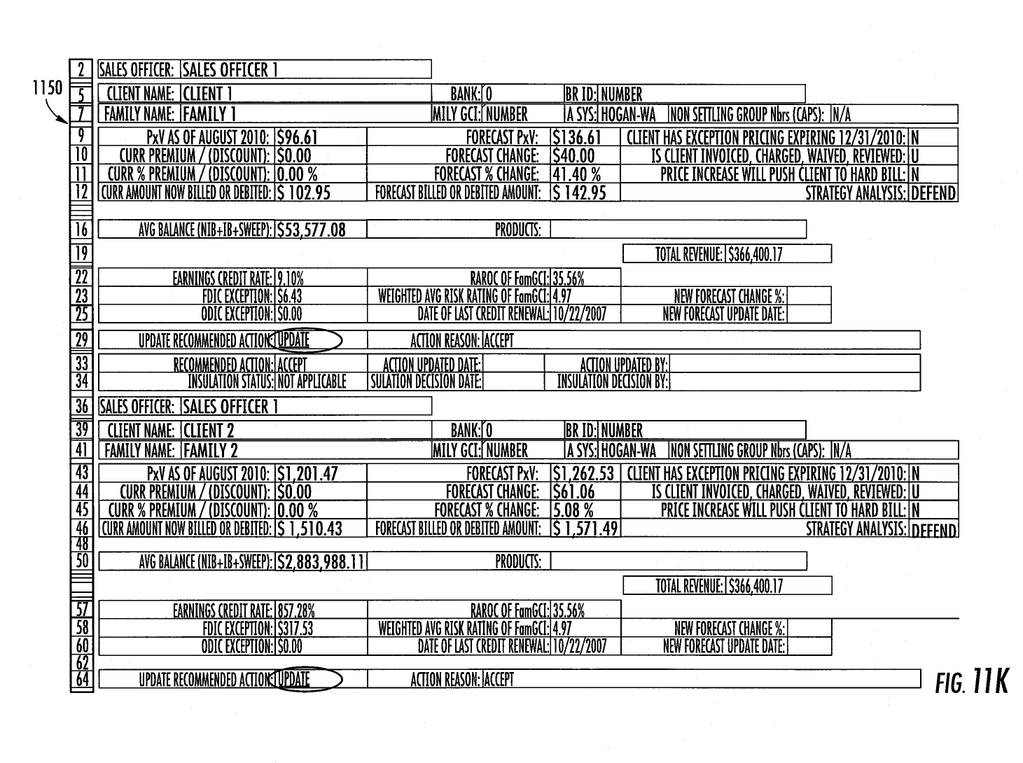

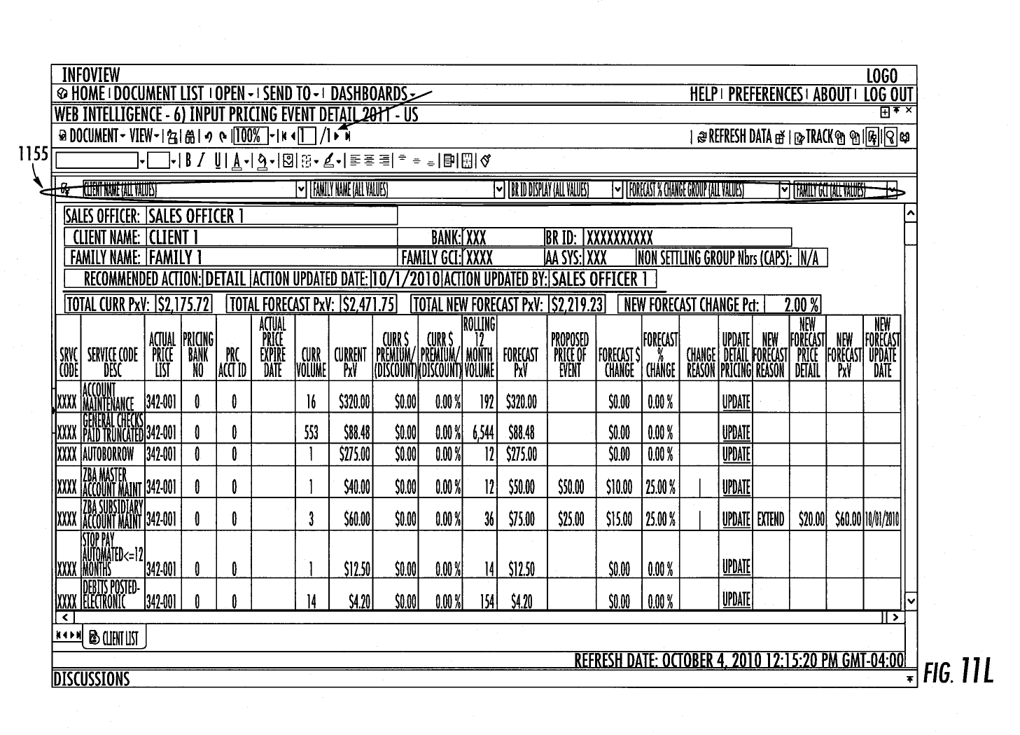

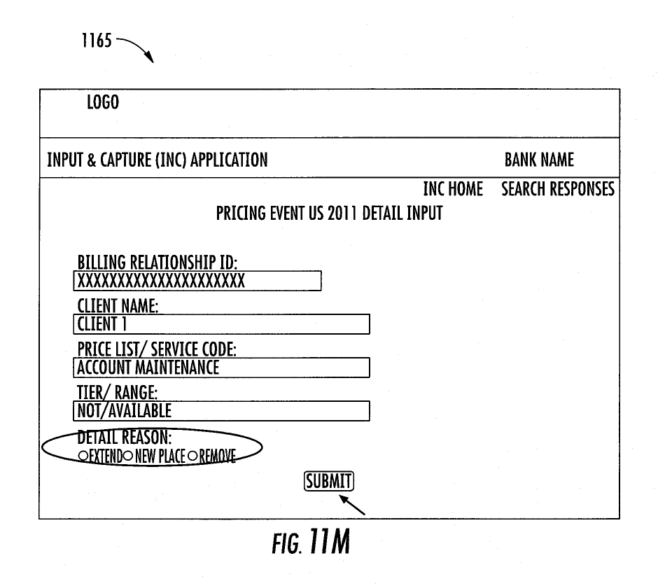

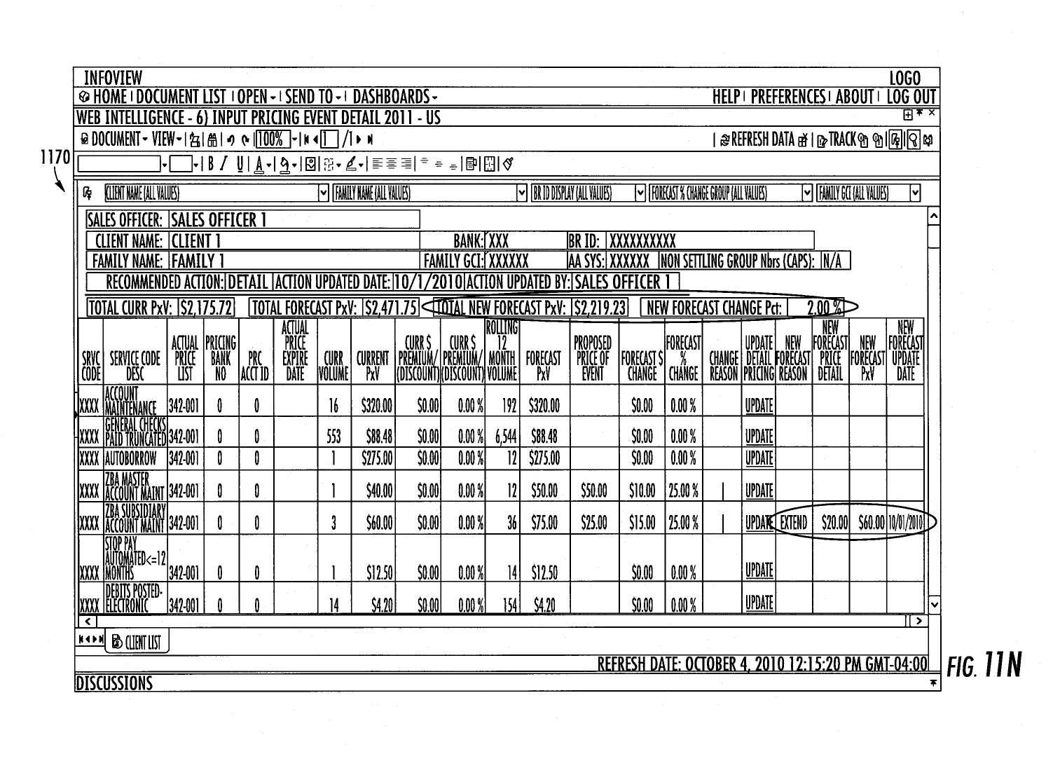

In various embodiments, the tool of the system increases efficiency of data input through streamlined graphical user interface front-end design as shown in FIGS. 11A-11N described below. For example, the tool provides users an opportunity to provide input concurrently while viewing data being displayed for review, such as treasury data being displayed for sales officer review during the price decisioning process. In such embodiments, the user is not required to navigate to a different screen or browser window in order to provide input. In some embodiments of the tool, the user is provided an opportunity to input multiple decisions simultaneously using one entry field. In some embodiments, the tool, once the user has chosen to make an entry, such as a pricing decision, the tool pops-up a window providing comments and/or instructions to the user. In some embodiments, the user is allowed to enter data or choices using one entry and multiple pop-ups providing comments and/or instructions.

Referring now to FIGS. 11A-11N, various screenshots of the treasury pricings sales tool are shown according to embodiments of the invention. In various embodiments, the system 101, 201, or 301 produces the treasury pricing sales tool, which is accessible via a plurality of workstations or otherwise by users such as sales officers and/or managing sales officers as discussed above with reference to FIG. 3.

Referring now to FIG. 11A, a screenshot of a document list navigation page 1100 of the treasury pricing sales tool is shown. In order to arrive at this page, in some embodiments, a user must go through an authentication page configured for authenticating the user's identity. In some embodiments, the user's identity determines which pieces of information and/or which decision-making options are provided to the user. Once the user is authenticated, the user is directed to a business objects home page (not shown). The user, in various embodiments has authenticated and has access to more than one tool, such as the treasury pricing sales tool described herein, and may access those other tools or other functionality from the business objects home page. The user may select to view a “document list” or, in some embodiments, may select the treasury pricing sales tool in order to be directed to the document list navigation page 1100 of FIG. 11A. The document list navigation page 1100 provides the user access to folders related to a current pricing event. As shown, the user may have access to a management reporting folder, a past events folder, a reference folder, and a sales decisioning folder in the embodiment shown. The management reporting folder, in some embodiments, includes some or all reporting that requires further approval. For example, in the case where the user is a managing sales officer, the management reporting folder provides an opportunity for the managing sales officer to review matters requiring further approval, such as insulation requests. The past events folder, in some embodiments, provides the user documentation and tools related to previous pricing events and/or other initiatives. The reference folder, in some embodiments, provides documents and/or other information, to the user for additional pricing analysis. For example, in some embodiments, the recommended standard price list is provided to the user. The sales decisioning folder, in some embodiments, provides the user with some or all the tools necessary for updating the client pricing decisions. Referring now to FIG. 11B, a screenshot of the document list navigation page 1100 where the user has selected the sales decisioning folder is shown. The user is given the opportunity to open the folder, add new folders, organize the folders or perform other operations with the folder listing.

Referring now to FIG. 11C, a screenshot of a sales decisioning tools list 1110 is illustrated. The user, for example, is provided an opportunity to view a pricing event relationship listing, which may include a comprehensive listing of client in the portfolio managed by the user and available for decisioning review. The user may also use the pricing event relationship listing to review various recommended decisioning actions, such as recommended product pricing. The input pricing event summary accepts user input regarding client pricing decisions at a billing relationship level. The input pricing event detail accepts user input regarding client pricing decisions at a service code level. The billing relationship level includes less granular detail regarding individual product pricing, and is thus a more comprehensive decision-making level, whereas the service code level includes additional detail regarding specific product pricing arrangements.

Referring now to FIG. 11D, a screenshot of a sales officer input screen 1115 is shown. To arrive at this screen, the user selects pricing event from the navigation page 1100 and then sales decisioning. The user then selects a pricing event relationship listing as shown in the sales decisioning tools list 1110. At screen 1115, the user is prompted for inputting a sales officer's name so that a report may be created including the clients associated with that sales officer. Referring now to FIG. 11E, a screenshot of a client report 1120 including a listing of the clients associated with the sales officer is shown. The report may be filtered for selected clients at the discretion of the user based on recommended action based on client decisioning updates, client name, family name and the like. The user may use the client report 1120 to review decisioning actions after any updates or as desired, the user may refresh the report manually be selecting “refresh data”. Any fields that have recently been updated will populate with newly received information. In some embodiments, some or all the data and/or information provided by the client report 1120 updated periodically, such as every five minutes. Referring now to FIG. 11F, a screenshot of an exporting screen 1125 is shown. The user may select to save and/or export the client report, or in some embodiments, other reports created by the tool, using the exporting screen 1125.

Referring now to FIG. 11G, a screenshot of a summary report screen 1130 is shown. To arrive at this screen, the user selects pricing event form the navigation page 1100 and then sales decisioning. The user then selects input pricing event summary as shown in the sales decisioning tools list 1110. The summary report screen 1130 includes information regarding the individual billing relationship available for decisioning review. The summary report may, in some embodiments, be filtered for selected clients at the user's discretion. The filtering may be performed by client name, family name, billing relationship identification number, forecasted percentage change in pricing and the like. In various embodiments, the user may manually choose to update the data and information in the report by selecting the refresh data link. In some embodiments, the data is updated regularly, such as every five minutes. As shown on the summary report screen 1130, the tool allows the user an opportunity to select “update” to submit client pricing. After selecting update, in some embodiments, the user is navigated to an authentication page. After authenticating, the user is navigated to a new tab providing a pricing event summary input screen 1135 as shown in the screenshot of FIG. 11H. The summary input 1135 includes input fields for receiving user input regarding billing relationship identification number, client name, and a recommended action, such as, for example, accepting, detailing, insulating, reassigning, or indicating that the client is no longer a client of the financial institution. In some embodiments, based on the summary report from which the user selected to update, for example, in the event the summary report regarded only one client, then the billing relationship identification number and the client name may be pre-filled and the only field for providing input is the recommended action field.

The various recommended actions the user may choose from are options for initial pricing decisions based on the summary data listed for the billing relationship. One option is to accept. Accepting a price increase indicates the user accepts the increase based on moving to an existing or new standard pricing scheme. The next option is detail. When the user chooses detail, the tool provides a review behind the impact and pricing decision for every service code, that is, for every product. This option also allows the user to select the impact to the client and/or the product as discussed further below. The next option is insulate. When the user chooses insulate, the client is excluded from the current pricing event. In some instances, the insulation decisions are reviewable by managers to ensure alignment with the pricing policies and/or strategies of the various line-of-business or group within the financial institution. When the user chooses to reassign, the client is reassigned to a different sales officer and/or team.

Referring now to FIG. 11I, an illustration of various dropdown menus is shown. The first dropdown menu 1140A is presented to the user when the user selects detail. The dropdown menu 1140A provides a variety of client impacts to choose from. For example, the user is provided an opportunity to select to limit the pricing impact to 2%. The suggested pricing impact percentages are calculated by the system based on several parameters such as other pricing changes for the client, client risk and the like. The user is also given an opportunity to manually detail, which refers to the user or some other associate completing an individual line item review without automated suggestions put forth by the system. An insulate dropdown menu 1140B provides the user an opportunity to select an insulation reason, such as, for example, the client's status as a contract client, a growing relationship with the client, new business having been added to the client portfolio within the last twelve months, other pricing actions occurring within the last twelve months, significant client servicing issues, or some other reason. A reassign dropdown menu 1140C provides the user an opportunity to select the sales officer to which the client should be reassigned. After inputting the required information, the user may submit the information, and in some embodiments, is presented a confirmation screen.

Referring now to FIG. 11J, a screenshot of an export screen 1145 is shown. The user may choose to export the summary report into one of various formats such as an EXCEL spreadsheet, PDF or other format. Referring now to FIG. 11K, a screenshot of a family report 1150 is shown. The family report is a feature whereby the user may view information regarding a number of clients related by family identification. This may be useful for the user to gain insight into the data and information related to a family of clients rather than requiring the user to pull each client in a family individually.

Referring now to FIG. 11L, screenshots of a detail report 1155 is shown. To navigate to the detail report 1155, the user selects the document list, pricing event, sales decisioning and then input pricing event detail from the navigation page 1100. The detail report receives user input regarding client pricing decisions at an individual service code level. In other words, the detail report allows the user to select to update one or more of the specific products or line items associated with a particular client. Once the user selects a product, the user must enter the sales officer name associated with the product. In some embodiments, the sales officer name input is the name of the user, and the system stores the name of the sales officer requesting the update or change. After updating a product price, the user may refresh the report. In some embodiments, the report automatically refreshes, such as every five minutes. The detail report includes fields for indicating the last change reason. When a user inputs a change in the pricing for a product, the user is prompted to input a change reason, which is presented by the tool in the detail report. A change reason of “I” indicates an increase to standard price, a change reason of “E” indicates an existing concession is expiring and will default to the standard price, and a change reason of “I/E” indicates an existing concession is expiring and the client will go to the new standard price.

In some embodiments, once selecting update, the user is authenticated in some embodiments, and then navigated to a new tab, as shown in the screenshot 1165 of FIG. 11M. The user input information regarding the detail reason, such as whether the reason is extend, new price, or remove. The “extend” detail reason is for when a new standard price is being established and indicates the user's desire to extend former pricing. The “new price” selection indicates that there is a new client price, and the tool provides a field for input of the new price. Choosing to “remove” indicates that a concession to a former price will be removed. In some instances, the tool provides a field for the user to input when the removal of the concession will occur. Once the user has submitted input, a confirmation screen is presented.

Referring now to FIG. 11N, a screenshot of an updated detail report 1170 is shown. The updated detail report 1170 presents the detail report including any information, such as pricing changes submitted by the user since the last update. In some embodiments, the tool also provides the user various other options. For example, the user may be provided an opportunity to create client notification letters and proforma statements at the user's discretion. That is, the user may have the opportunity to create additional correspondence over an above any automatic correspondence created and/or communicated by the system.

According to embodiments of the invention, a method for providing a treasury pricing tool includes retrieving data from one or more source databases, initiating presentation, using a processing device, of a user interface configured to present some or all the data to a user, receiving input regarding a product pricing recommendation, presenting, via the user interface, one or more reports configured to assist the user in making a final determination regarding product pricing, and receiving user input regarding a final product pricing recommendation. In some embodiments, the data may include product pricing data, risk data, credit data, profitability data and/or liquidity data. In some embodiments, the method also includes communicating the final product pricing recommendation from the user to a second user and receiving, from the second user, approval for the final product pricing recommendation.

As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities.

As used herein, a “communication device” generally includes a modem, server, transceiver, and/or other device for communicating with other devices directly or via a network, and/or a user interface for communicating with one or more users. As used herein, a “user interface” generally includes a display, mouse, keyboard, button, touchpad, touch screen, microphone, speaker, LED, light, joystick, switch, buzzer, bell, and/or other user input/output device for communicating with one or more users.

As used herein, a “memory device” or “memory” generally refers to a device or combination of devices including one or more forms of non-transitory computer-readable media for storing instructions, computer-executable code, and/or data thereon. Computer-readable media is defined in greater detail herein below. It will be appreciated that, as with the processing device, each communication interface and memory device may be made up of a single device or many separate devices that conceptually may be thought of as a single device.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor/processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. A method for providing a treasury pricing tool, the method comprising:
retrieving data from one or more source databases;
initiating presentation, using a processing device, of a user interface configured to present some or all the data to a user;
receiving input regarding a product pricing recommendation;
presenting, via the user interface, one or more reports configured to assist the user in making a final determination regarding product pricing; and
receiving user input regarding a final product pricing recommendation.

2. The method of claim 1, further comprising:
communicating the final product pricing recommendation received from the user to a second user; and
receiving, from the second user, approval for the final product pricing recommendation.

3. The method of claim 1, wherein presenting one or more reports comprises presenting a recommendation analysis report to the user.

4. The method of claim 1, wherein presenting one or more reports comprises presenting a forecast report to the user.

5. The method of claim 1, further comprising:
preparing one or more pricing exception decisions; and
communicating the one or more pricing exception decisions to the user.

6. The method of claim 1, further comprising:
receiving one or more client impact evaluations from the user; and
storing the one or more client impact evaluations, thereby making the one or more client impact evaluations available for presentation via the user interface to the user or a second user.

7. The method of claim 1, further comprising:
communicating one or more insulation or detail requests to a second user; and
receiving input from the second user regarding whether each of the one or more insulation or detail requests is approved.

8. The method of claim 7, further comprising:
communicating whether the one or more insulation or detail requests is approved to the user.

9. The method of claim 8, wherein at least one of the one or more insulation or detail requests is declined based on the input received from the second user, the method further comprising:
receiving one or more responses from the user regarding the one or more declined insulation or detail requests; and
communicating the one or more responses to the second user.

10. The method of claim 1, wherein the data comprises product pricing data.

11. The method of claim 1, wherein the data comprises risk data.

12. The method of claim 1, wherein the data comprises credit data.

13. The method of claim 1, wherein the data comprises profitability data.

14. The method of claim 1, wherein the data comprises liquidity data.

15. The method of claim 1, wherein presenting one or more reports configured to assist the user in making a final determination regarding product pricing comprises:
calculating, based at least in part on the product pricing recommendation, an overall fee impact.

16. The method of claim 1, wherein receiving input regarding the product pricing recommendation comprises receiving input from a market team, and wherein presenting one or more reports comprises presenting the product pricing recommendation of the market team to the user for use in determining a final product pricing recommendation.

17. The method of claim 1, wherein receiving input regarding the product pricing recommendation comprises receiving input from the user.

18. The method of claim 1, wherein retrieving data from one or more source databases comprises communicating a plurality of requests for treasury data to a plurality of databases, each of the plurality storing treasury data in a different format, each of the plurality of requests for treasury data including instructions for configuring the treasury data in a normalized format.

19. The method of claim 18, wherein retrieving data from one or more source databases further comprises receiving a plurality of responses to the plurality of requests, each of the plurality of responses comprising treasury data formatted in the normalized format.

20. The method of claim 19, further comprising:
initiating presentation of some or all the treasury data formatted in the normalized format, via the user interface, to the user or a second user, wherein the treasury data comprises information regarding previous or current product pricing for one or more clients, the information useful in making the final product pricing decision.

21. A system for providing a treasury pricing tool, the system comprising a processing device configured for:
retrieving data from one or more source databases;
initiating presentation of a user interface configured to present some or all the data to a user;
receiving input regarding a product pricing recommendation;
presenting, via the user interface, one or more reports configured to assist the user in making a final determination regarding product pricing; and
receiving user input regarding a final product pricing recommendation.

22. The system of claim 21, wherein the processing device is further configured for:
communicating the final product pricing recommendation received from the user to a second user; and
receiving, from the second user, approval for the final product pricing recommendation.

23. The system of claim 21, wherein presenting one or more reports comprises presenting a recommendation analysis report to the user.

24. The system of claim 21, wherein presenting one or more reports comprises presenting a forecast report to the user.

25. The system of claim 21, wherein the processing device is further configured for:
preparing one or more pricing exception decisions; and
communicating the one or more pricing exception decisions to the user.

26. The system of claim 21, wherein the processing device is further configured for:
receiving one or more client impact evaluations from the user; and
storing the one or more client impact evaluations, thereby making the one or more client impact evaluations available for presentation via the user interface to the user or a second user.

27. The system of claim 21, wherein the processing device is further configured for:
communicating one or more insulation or detail requests to a second user; and
receiving input from the second user regarding whether each of the one or more insulation or detail requests is approved.

28. The system of claim 27, wherein the processing device is further configured for:
communicating whether the one or more insulation or detail requests is approved to the user.

29. The system of claim 28, wherein at least one of the one or more insulation or detail requests is declined based on the input received from the second user, the system further configured for:
receiving one or more responses from the user regarding the one or more declined insulation or detail requests; and
communicating the one or more responses to the second user.

30. The system of claim 21, wherein presenting one or more reports configured to assist the user in making a final determination regarding product pricing comprises:
calculating, based at least in part on the product pricing recommendation, an overall fee impact.

31. The system of claim 21, wherein receiving input regarding the product pricing recommendation comprises receiving input from a market team, and wherein presenting one or more reports comprises presenting the product pricing recommendation of the market team to the user for use in determining a final product pricing recommendation.

32. The system of claim 21, wherein receiving input regarding the product pricing recommendation comprises receiving input from the user.

33. A computer program product comprising a non-transient computer-readable medium comprising computer-executable instructions for providing a treasury pricing tool, the instructions comprising:
instructions for retrieving data from one or more source databases;
instructions for initiating presentation of a user interface configured to present some or all the data to a user;
instructions for receiving input regarding a product pricing recommendation;
instructions for presenting, via the user interface, one or more reports configured to assist the user in making a final determination regarding product pricing; and
instructions for receiving user input regarding a final product pricing recommendation.

34. The computer program product of claim 33, wherein the instructions further comprise:
instructions for communicating the final product pricing recommendation received from the user to a second user; and
instructions for receiving, from the second user, approval for the final product pricing recommendation.

35. The computer program product of claim 33, wherein the instructions for presenting one or more reports comprise instructions for presenting a recommendation analysis report to the user.

36. The computer program product of claim 33, wherein the instructions for presenting one or more reports comprise instructions for presenting a forecast report to the user.

37. The computer program product of claim 33, wherein the instructions further comprise:
instructions for preparing one or more pricing exception decisions; and
instructions for communicating the one or more pricing exception decisions to the user.

38. The computer program product of claim 33, wherein the instructions further comprise:
instructions for receiving one or more client impact evaluations from the user; and
instructions for storing the one or more client impact evaluations, thereby making the one or more client impact evaluations available for presentation via the user interface to the user or a second user.

39. The computer program product of claim 33, wherein the instructions further comprise:
instructions for communicating one or more insulation or detail requests to a second user; and
instructions for receiving input from the second user regarding whether each of the one or more insulation or detail requests is approved.

40. The computer program product of claim 39, wherein the instructions further comprise:
instructions for communicating whether the one or more insulation or detail requests is approved to the user.

41. The computer program product of claim 40, wherein at least one of the one or more insulation or detail requests is declined based on the input received from the second user, the instructions further comprising:
instructions for receiving one or more responses from the user regarding the one or more declined insulation or detail requests; and
instructions for communicating the one or more responses to the second user.

42. The computer program product of claim 33, wherein the instructions for presenting one or more reports configured to assist the user in making a final determination regarding product pricing comprise:
instructions for calculating, based at least in part on the product pricing recommendation an overall fee impact.

43. The computer program product of claim 33, wherein the instructions for receiving input regarding the product pricing recommendation comprise instructions for receiving input from a market team, and wherein presenting one or more reports comprises presenting the product pricing recommendation of the market team to the user for use in determining a final product pricing recommendation.

44. The computer program product of claim 33, wherein the instructions for receiving input regarding the product pricing recommendation comprises receiving input from the user.

45. A method for providing a treasury pricing tool, the method comprising:
retrieving data comprising treasury data, credit data, and risk data, the data retrieved from one or more source databases;
initiating presentation, using a processing device, of a user interface configured to present some or all the treasury data, some or all the credit data, and some or all the risk data to a user;
receiving input regarding a product pricing recommendation;
storing one or more client impact evaluations, thereby making the one or more client impact evaluations available for presentation via the user interface to the user or a second user;
presenting, via the user interface, one or more reports configured to assist the user in making a final determination regarding product pricing, the one or more reports comprising a report regarding one or more client impact evaluations; and
receiving user input regarding a final product pricing recommendation.

46. The method of claim 45, further comprising:
communicating the final product pricing recommendation received from the user to a second user; and
receiving, from the second user, approval for the final product pricing recommendation.

47. The method of claim 45, wherein presenting one or more reports comprises presenting a recommendation analysis report to the user.

48. The method of claim 45, wherein presenting one or more reports comprises presenting a forecast report to the user.

49. The method of claim 45, further comprising:
preparing one or more pricing exception decisions; and
communicating the one or more pricing exception decisions to the user.

50. The method of claim 45, further comprising:
receiving one or more client impact evaluations from the user.

51. The method of claim 45, further comprising:
communicating one or more insulation or detail requests to a second user; and
receiving input from the second user regarding whether each of the one or more insulation or detail requests is approved.

52. The method of claim 51, further comprising:
communicating whether the one or more insulation or detail requests is approved to the user.

53. The method of claim 52, wherein at least one of the one or more insulation or detail requests is declined based on the input received from the second user, the method further comprising:
receiving one or more responses from the user regarding the one or more declined insulation or detail requests; and
communicating the one or more responses to the second user.

54. The method of claim 45, wherein presenting one or more reports configured to assist the user in making a final determination regarding product pricing comprises:
calculating, based at least in part on the product pricing recommendation, an overall fee impact; and wherein storing one or more client impact evaluations comprises:
storing the calculated overall fee impact.

55. The method of claim 45, wherein receiving input regarding the product pricing recommendation comprises receiving input from a market team, and wherein presenting one or more reports comprises presenting the product pricing recommendation of the market team to the user for use in determining a final product pricing recommendation.

56. The method of claim 45, wherein receiving input regarding the product pricing recommendation comprises receiving input from the user.

57. A method for providing a treasury pricing tool, the method comprising:
retrieving data, the data retrieved from one or more source databases;
initiating presentation, using a processing device, of a user interface configured to present some or all the data to a user;
receiving input regarding a final product pricing decision; and
initiating implementation of the final product pricing decision.

58. The method of claim 57, further comprising:
presenting, via the user interface, one or more reports configured to assist the user in making the final determination regarding product pricing.

59. The method of claim 57, further comprising:
monitoring progress of implementation of the final product pricing decision.

60. The method of claim 59, wherein monitoring progress of implementation of the final product pricing decision comprises:
initiating presentation of one or more progress reports, via the user interface, to the user or a second user, wherein the one or more progress reports comprise information regarding the progress of implementation of the final product pricing decision in view of one or more product pricing implementation goals.

61. The method of claim 57, wherein initiating implementation of the final product pricing decision comprises:
initiating communication of product pricing information corresponding to the final product pricing decision to a plurality of billing applications configured for generating billing communications to one or more clients affected by the final product pricing decision.

62. The method of claim 57, wherein retrieving data from one or more source databases comprises communicating a plurality of requests for treasury data to a plurality of databases, each of the plurality storing treasury data in a different format, each of the plurality of requests for treasury data including instructions for configuring the treasury data in a normalized format.

63. The method of claim 62, wherein retrieving data from one or more source databases further comprises receiving a plurality of responses to the plurality of requests, each of the plurality of responses comprising treasury data formatted in the normalized format.

64. The method of claim 63, further comprising:
initiating presentation of some or all the treasury data formatted in the normalized format, via the user interface, to the user or a second user, wherein the treasury data comprises information regarding previous or current product pricing for one or more clients, the information useful in making the final product pricing decision.
